(19) United States
(12) Patent Application Publication
(10) Pub. No.: US 2017/0359485 A1
(43) Pub. Date: Dec. 14, 2017

(54) IMAGE PROCESSING APPARATUS AND IMAGE PROCESSING METHOD

(71) Applicant: CANON KABUSHIKI KAISHA, Tokyo (JP)

(72) Inventor: Takuya Shimada, Utsunomiya-shi (JP)

(21) Appl. No.: 15/536,068

(22) PCT Filed: Dec. 3, 2015
(86) PCT No.: PCT/JP2015/006011

§ 371 Date: Jun. 14, 2017

(30) Foreign Application Priority Data
Dec. 16, 2014 (JP) 2014-254595

(51) Int. Cl. H04N 1/405; H04N 1/60; B41M 7/00; H04N 1/64

(52) U.S. Cl. CPC H04N 1/4053; H04N 1/646; H04N 1/6019; B41M 7/0027; H04N 1/6013; H04N 1/6088

(57) ABSTRACT

An image processing apparatus includes an input unit configured to receive first material appearance data representing a material appearance of an image, a material appearance mapping unit configured to convert the first material appearance data into second material appearance data corresponding to a material appearance reproducible by a material appearance reproducing apparatus, and a conversion unit configured to convert the second material appearance data into control data for reproducing the material appearance of the image using the material appearance reproducing apparatus. The first material appearance data includes a gloss signal corresponding to a specular gloss and a gloss signal corresponding to an image clarity.

### TECHNICAL FIELD

The present invention relates to image processing for reproducing the material appearance of images.

### BACKGROUND ART

The need for image processing that reproduces the material appearance of images by controlling the gloss in addition to colors has been increasing. PTL 1 describes a technology for reproducing specular reflection light from an object to be reproduced within the dynamic range of the display device to excellently reproduce the gloss of the object using computer graphic techniques.

### CITATION LIST

### Patent Literature

PTL 1: Japanese Patent Laid-Open No. 2010-246049

### SUMMARY OF INVENTION

### Technical Problem

However, according to PTL 1, there still remains a mismatch between the range of the material appearance further including a material appearance element other than the specular reflection light from the object to be reproduced and the range of the material appearance reproducible by a material appearance reproducing apparatus, such as a printer. Accordingly, if the material appearance of the object to be reproduced cannot be reproduced by the material appearance reproducing apparatus, a reproduced object corresponding to the full reproduction range of the material appearance reproducing apparatus cannot be obtained or the material appearance of the object to be reproduced is damaged. As a result, a user of the material appearance reproducing apparatus cannot obtain reproduction of a desired material appearance.

The present invention provides image processing for obtaining a reproduced object having a desired material appearance fully using the reproduction range of the material appearance reproducing apparatus.

According to an aspect of the present invention, an image processing apparatus includes an input unit configured to receive first material appearance data representing a material appearance of an image, a material appearance mapping unit configured to convert the first material appearance data into second material appearance data corresponding to a material appearance reproducible by a material appearance reproducing apparatus, and a conversion unit configured to convert the second material appearance data into control data for reproducing the material appearance of the image using the material appearance reproducing apparatus. The first material appearance data includes a gloss signal corresponding to a specular gloss and a gloss signal corresponding to an image clarity.

Further features of the present invention will become apparent from the following description of exemplary embodiments with reference to the attached drawings.

### BRIEF DESCRIPTION OF DRAWINGS

FIG. 1 is a flowchart of a material appearance reproducing procedure according to a first exemplary embodiment.

FIG. 2 is a flowchart of a material appearance mapping procedure according to the first exemplary embodiment.

FIG. 3 is a flowchart of a gloss mapping procedure according to the first exemplary embodiment.

FIG. 4 is a flowchart of the first half of block building procedure according to the first exemplary embodiment.

FIG. 5 is a flowchart of the second half of the block building procedure according to the first exemplary embodiment.

FIG. 6A is a schematic illustration of the structure of a head cartridge according to the first exemplary embodiment.

FIG. 6B is a schematic illustration of the structure of the head cartridge according to the first exemplary embodiment.

FIG. 7 is a block diagram of the hardware configuration of a material appearance reproducing system according to the first exemplary embodiment.

FIG. 8 is a flowchart of a gloss mapping procedure according to a first modification of the first exemplary embodiment.

FIG. 9 is a block diagram illustrating the functional configuration of the material appearance reproducing system according to the first exemplary embodiment.

FIG. 10 is a schematic illustration of the order in which processing areas are scanned in the block building process.

FIG. 11 is a schematic illustration example of a device properties table.

FIG. 12A is a schematic illustration of an example of a pass mask.

FIG. 12B is a schematic illustration of an example of a pass mask.

FIG. 12C is a schematic illustration of an example of a pass mask.

FIG. 12D is a schematic illustration of an example of a pass mask.

FIG. 12E is a schematic illustration of an example of a pass mask.

FIG. 12F is a schematic illustration of an example of a pass mask.

FIG. 12G is a schematic illustration of an example of a pass mask.

FIG. 13 is a schematic illustration of typical characteristics of multi angle distribution of reflection.

FIG. 14 is a block diagram of the functional configuration of a material appearance reproducing system according to a second exemplary embodiment.

FIG. 15 is a schematic illustration of an example of a material appearance reproduction table.

FIG. 16 is a flowchart of a material appearance reproducing procedure according to the second exemplary embodiment.

FIG. 17 is a schematic illustration of material appearance data used for describing an example of a verification technique.

FIG. 18 illustrates an example of CG images displayed in a gloss adjustment UI according to a first modification of a third exemplary embodiment.

FIG. 19 is a schematic illustration of gloss mapping.

FIG. 20A is a schematic illustration illustrating the specular gloss and the image clarity.

FIG. 20B is a schematic illustration illustrating the specular loss and the image clarity.

FIG. 20C is a schematic illustration illustrating the specular gloss and the image clarity.

FIG. 21 is a flowchart of a material appearance reproducing procedure according to the third exemplary embodiment.

FIG. 22 is a schematic illustration of an example of a gloss adjustment UI according to the third exemplary embodiment.

FIG. 23 is a block diagram of the functional configuration of a material appearance reproducing system according to the third exemplary embodiment.

FIG. 24 is a schematic illustration of a gloss adjustment UI according to a first modification of the third exemplary embodiment.

### DESCRIPTION OF EMBODIMENTS

Exemplary embodiments of the present invention are described in detail below with reference to the accompanying drawings.

### First Exemplary Embodiment

### Material Appearance Reproducing Technique 1

A material appearance reproducing technique according to the present exemplary embodiment is described first. As used herein the term “reproduction of material appearance” refers to outputting a reproduced object having an appearance that is the same as that of the object to be reproduced. In addition, the term “material appearance” refers to a set of properties to be matched between the reproduced object and the object to be reproduced to have the same appearance when the two are comparatively observed. The material appearance has a plurality of elements such as color, gloss, internal scattering, and shape. If the material appearance can be quantitatively expressed using a value, a reproduced object having an appearance that is the same as that of the object to be reproduced can be obtained by outputting the reproduced object so that the value is the same for the reproduced object and the object to be reproduced. Hereinafter, the value is referred to as a “material appearance signal”. If the object to be reproduced is, for example, a printout that is flat and that has a sufficiently small surface roughness, a reproduced object having a shape that is substantially the same as that of the object to be reproduced can be obtained by printing an image on a flat medium of the same type as the printout. In such a case, the important elements of the material appearance are the color and the gloss. That is, the material appearance is formed from the two elements. Even in the other cases, the color and gloss are important elements of the material appearance.

As a color signal that is the numerical representation of color, the value defined in existing CIELAB can be used, for example. CIELAB mainly represents the characteristics regarding the brightness and chromaticity of diffuse reflection light. As used herein, the term “diffuse reflection light” refers to reflection light in a diffuse reflection direction which is defined as directions other than the specular direction and its vicinity. By printing the reproduced object so that the CIELAB value of the reproduced object is the same as that of the object to be reproduced, the appearance in terms of color in the diffuse reflection direction can be made to be substantially the same as that of the object to be reproduced.

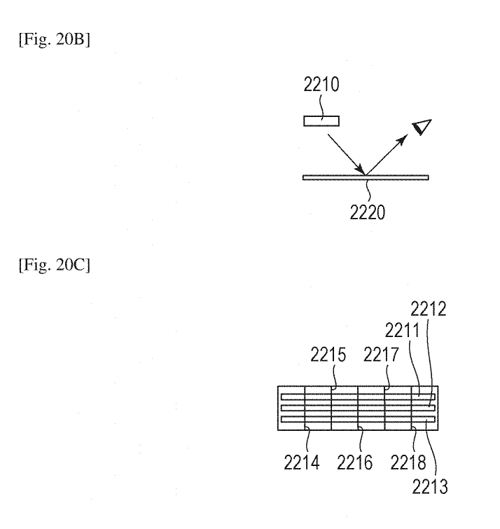

As a gloss signal, which is a numerical representation of the gloss, the value of widely used specular gloss, the value of widely used degree of sharpness of reflected, or the value of widely used reflection haze can be employed, for example. The specular gloss represents the properties regarding the brightness of specular reflection light. The values obtained by dividing the degree of sharpness of reflected and the specular gloss by the reflection haze represent the properties regarding the sharpness of an illumination image produced by reflection at a surface of the object. Hereinafter, the properties regarding the sharpness of the illumination image is referred to as “image clarity”. As the image clarity becomes higher, the degree of sharpness of reflected becomes higher and, thus, the value obtained by dividing the specular gloss by the reflection haze becomes higher. FIGS. 20A to 20C are schematic illustrations of the specular gloss and the image clarity. Each of images 2231 to 2234 illustrated in FIG. 20A is the image of an illumination light source produced by reflection at a surface of a sample. More specifically, as illustrated in FIG. 20B, each of the images 2231 to 2234 is the image of the illumination light source 2210 produced by reflection at a surface of a sample 2220 when viewed in the specular direction of the illumination light source 2210. FIG. 20C illustrates the configuration of the illumination light source 2210 of this example. The illumination light source 2210 includes three linear fluorescent light tubes 2211 to 2213 and five louvers 2214 to 2218.

The image 2231 illustrated in FIG. 20A is obtained when both the specular gloss and image clarity of the sample 2220 are high. The image of the illumination light source 2210 produced by reflection at a surface of the sample 2220 is bright and sharp. The image 2232 is obtained when both the specular gloss and image clarity of the sample 2220 are low. The image of the illumination light source 2210 produced by reflection at the surface of the sample 2220 is dark and blurred. The image 2233 is obtained when the specular gloss of the sample 2220 is high but the image clarity is low. The image of the illumination light source 2210 produced by reflection at the surface of the sample 2220 is bright but blurry. The image 2234 is obtained when the specular gloss of the sample 2220 is low but the image clarity is high. The image of the illumination light source 2210 produced by reflection at the surface of the sample 2220 is dark but sharp. If the reproduced object is printed so that the gloss signal corresponding to the specular gloss and the gloss signal corresponding to the image clarity are the same as those of the object to be reproduced, the brightness and the sharpness of the illumination image produced by reflection can be made to be substantially the same as those of the object to be reproduced. Conversely, even when only one of the specular gloss and the image clarity is the same, the appearances are not the same. That is, to obtain excellent reproduced material appearance, it is desirable that both the specular gloss and the image clarity be controlled.

### Material Appearance Reproducing Procedure

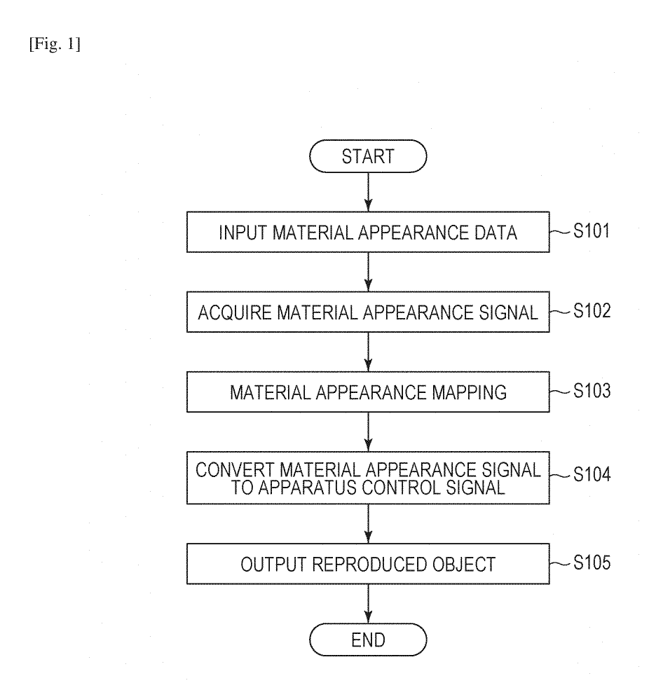

FIG. 1 is a flowchart illustrating the steps (the processes) of a material appearance reproducing procedure according to the first exemplary embodiment. In step S101, the material appearance data of the object to be reproduced is input. For example, the material appearance data is image data formed from a material appearance signal corresponding to CIELAB, the specular gloss, and the image clarity. That is, the material appearance data includes a CIELAB-based color signal and a gloss signal corresponding to the specular gloss and image clarity for each of small areas. Note that the image data may be measurement data itself (described in more detail below). In addition, hereinafter, each of the small areas that constitute the material appearance data is referred to as an “area”, an “image area”, or a “pixel”. In step S102, a material appearance signal is acquired from the material appearance data input in step S101. For example, a color signal or a gloss signal is acquired from the image data. Subsequently, in step S103, the material appearance signal acquired in step S102 is converted into a material appearance signal corresponding to the material appearance reproducible by the material appearance reproducing apparatus. The process in this step is referred to as “material appearance mapping”. The material appearance mapping is described in more detail below. Subsequently, in step S104, the material appearance signal converted in step S103 is converted into a control signal to the material appearance reproducing apparatus. The material appearance reproducing apparatus is, for example, an image printing apparatus, such as a printer. The control signal is, for example, a signal regarding the amount of a color material provided in the image printing apparatus. The control signal is described in more detail below. Finally, in step S105, a reproduced object is output by the material appearance reproducing apparatus on the basis of the control signal obtained in step S104. Note that the process in each step may be performed for each of the pixels or all the pixels. In the latter case, step S103 is a step of converting the material appearance signals that constitute the input material appearance data into the material appearance data constituted by the material appearance signals corresponding to the material appearance reproducible by the material appearance reproducing apparatus. Similarly, step S104 is a step of converting the material appearance data converted in step S103 into control data constituted by the control signals of the material appearance reproducing apparatus.

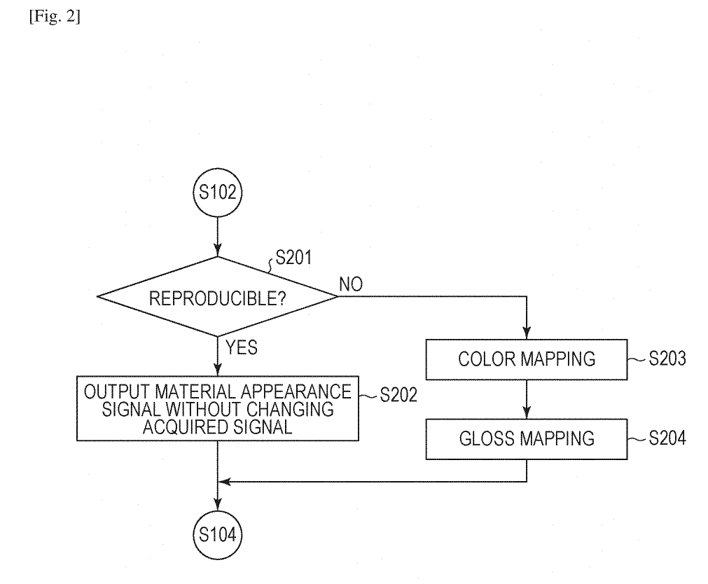

FIG. 2 is a flowchart illustrating the steps (the processes) of the material appearance mapping procedure. FIG. 2 illustrates the details of step S103 illustrated in FIG. 1. In step S201, it is determined whether the material appearance signal obtained in step S102 is a material appearance signal corresponding to the material appearance reproducible by the material appearance reproducing apparatus. For example, a combination of the values of the CIELAB, the specular gloss, and the image clarity that are reproducible by the material appearance reproducing apparatus and that are measured in advance is prestored as output material appearance reproducible range information. If the material appearance signal obtained in step S102, that is, a combination of CIELAB, the specular gloss, and the image clarity is within the output material appearance reproducible range information, it is determined that the material appearance signal obtained in step S102 is a material appearance signal reproducible by the material appearance reproducing apparatus. Thereafter, the processing proceeds to step S202. Otherwise, it is determined that the material appearance signal is a material appearance signal un reproducible by the material appearance reproducing apparatus. Thereafter, the processing proceeds to step S203. In step S202, the material appearance signal obtained in step S102 is not converted and is directly output as a converted material appearance signal. Thereafter, the processing proceeds to step S104.

In step S203, the color signal is converted into a color signal corresponding to a color reproducible by the material appearance reproducing apparatus. The process in step S203 is referred to as “color mapping”. The color mapping is performed using an existing technique. For example, the color signal is converted into a color signal having a CIELAB color value reproducible by the material appearance reproducing apparatus and having a hue angle that is the same as that of the CIELAB obtained in step S102 and the smallest color difference ΔE. As the hue angle and the color difference ΔE, the value of a widely used ab hue angle and the value of widely used CIEDE2000 can be employed, respectively. Note that if the color signal obtained in step S102 is a color signal reproducible by the material appearance reproducing apparatus, the color signal is not converted and is directly output as a converted color signal. Thereafter, the processing proceeds to step S204.

In step S204, the gloss signal is converted into a gloss signal corresponding to the gloss reproducible by the material appearance reproducing apparatus. Thereafter, the processing proceeds to step S104. The process in step S204 is referred to as “gloss mapping”. In the gloss mapping according to the present exemplary embodiment, a gloss element of interest is changed in accordance with the spatial distribution of the material appearance signals obtained in step S102. For example, since for a granular area of the reproduced object that glitters, the degree of the specular gloss has a significant impact on the appearance, the reproducibility of the specular gloss is given more weight over the image clarity. Hereinafter, such an area is referred to as an “area having a large gloss change”. In contrast, for an area in which substantially uniform gloss is widely distributed or an area in which the gloss that gently changes is widely distributed, the degree of the image clarity has a significant impact on the appearance. Thus, the reproducibility of the image clarity is given more weight over the specular gloss. Hereinafter, such an area is referred to as an “area having a small gloss change”. In the gloss mapping according to the present exemplary embodiment, a determination signal used for determining whether an area to be processed is an area having a large gloss change or an area having a small gloss change is set on the basis of the spatial distribution of the material appearance signals. Note that the determination signal is described in more detail below. Thereafter, determination is made on the basis of the determination signal. For an area determined to be an area having a large gloss change, the reproducibility of the specular gloss is given more weight, and the gloss signal is converted. In contrast, for an area determined to be an area having a small gloss change, the reproducibility of the image clarity is given more weight, and the gloss signal is converted. The determination signal is set for each of the areas. The determination signal for an area of interest is set on the basis of the material appearance signal of the area of interest and the material appearance signals of areas of non-interest in the vicinity. Note that hereinafter, the area of interest is also referred to as a “pixel of interest”.

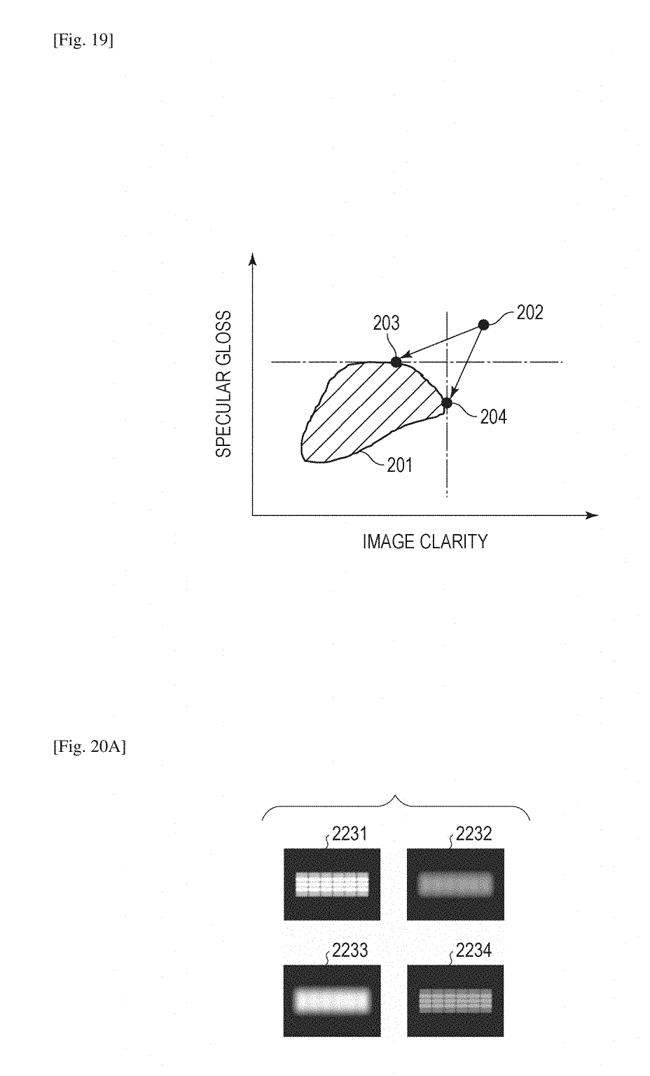

FIG. 19 is a schematic illustration of the gloss mapping. In FIG. 19, the abscissa represents a signal corresponding to the image clarity, and the ordinate represents a signal value corresponding to the specular gloss. A region 201 indicates the range of the specular gloss and the image clarity reproducible by the material appearance reproducing apparatus. For example, if the input data has the specular gloss and the image clarity indicated by a point 202, the conversion is made as follows. That is, for example, in an area for which determination is made so that the specular gloss is given more weight, the gloss signal is converted into the specular gloss and the image clarity indicated by a point 203. As a result, a reproduced object having a small difference between the input data and the specular gloss can be provided. In contrast, for example, in an area for which determination is made so that the reproducibility of the image clarity is given more weight, the gloss signal is converted into the specular gloss and the image clarity indicated by a point 204. As a result, a reproduced object having a small difference between the input data and the image clarity can be provided.

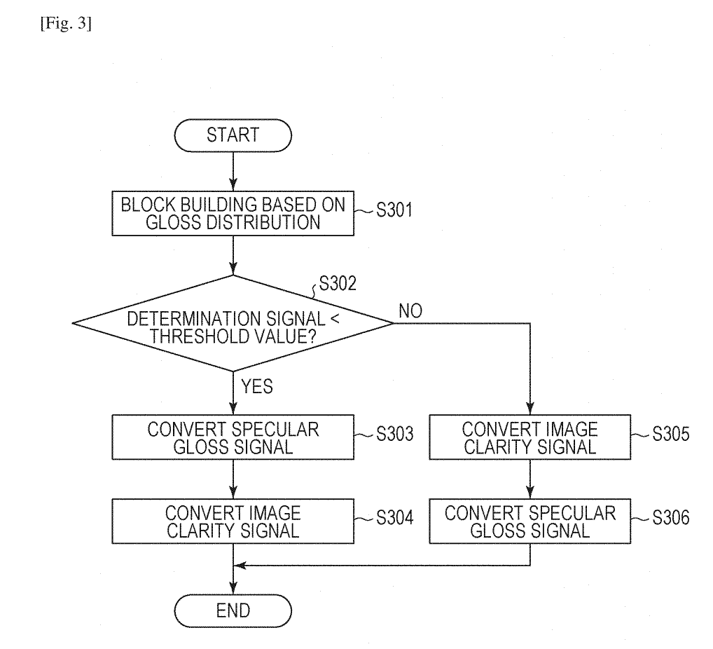

FIG. 3 is a flowchart illustrating the steps (the processes) of a detailed gloss mapping procedure. That is, FIG. 3 illustrates the process in step S204 illustrated in FIG. 2 in detail. In step S301, in the image, neighboring areas having a small gloss difference are grouped into the same block on the basis of the spatial distribution of the material appearance signals obtained in step S102, and a determination signal representing the size of the block is set for each of the areas. The process in step S301 is referred to as “block building”. More specifically, a block is generated using the spatial distribution of the gloss signal in the input data. An amount regarding the size of a space occupied by a block to which the area of interest belongs in the vicinity of the area of interest is used as the determination signal. A block is a set of areas including one or a plurality of successive areas in which the difference in gloss signal between neighboring areas is smaller than a predetermined threshold value. The determination signal that is small indicates that the area of interest is an area having a large gloss change. However, the determination signal that is large indicates that the area of interest is an area having a small gloss change. In this manner, an area having a large gloss change can be separated from an area having a small gloss change.

Subsequently, in step S302, one of conversion in which the reproducibility of the specular gloss is given more weight and conversion in which the reproducibility of the image clarity is given more weight is selected for each area on the basis of the input data. In this manner, the processing suitable for each area is performed and, thus, a reproduced object having an appearance that negligibly differs from that of the object to be reproduced indicated by the input data can be obtained. More specifically, it is determined whether the determination signal regarding the size of the block including the area of interest is lower than a predetermined threshold value. For example, the threshold value is set to 0.5. If the size of the block associated with the area of interest is smaller than the threshold value, it is determined that the area is an area of a large gloss change. Thereafter, the processing proceeds to step S303. Otherwise, it is determined that the area is an area of a small gloss change. Thereafter, the processing proceeds to step S305.

In step S303, the signal corresponding to the specular gloss is converted to obtain a converted signal. That is, the following signal is obtained: a signal corresponding to a specular gloss reproducible by the material appearance reproducing apparatus and having the smallest difference from the signal corresponding to the specular gloss obtained in step S102 while maintaining the color signal converted in step S203. Subsequently, in step S304, the signal corresponding to the image clarity is converted to obtain a converted signal. That is, the following signal is obtained: a signal corresponding to an image clarity reproducible by the material appearance reproducing apparatus and having the smallest difference from the signal corresponding to the image clarity obtained in step S102 while maintaining the color signal converted in step S203 and the signal corresponding to the specular gloss obtained in step S303.

In addition, in step S305, the signal corresponding to the image clarity is converted prior to converting the signal corresponding to the specular gloss to obtain a converted signal. That is, the following signal is obtained: a signal corresponding to an image clarity reproducible by the material appearance reproducing apparatus and having the smallest difference from the signal corresponding to the image clarity obtained in step S102 while maintaining the color signal converted in step S203. Subsequently, in step S306, the signal corresponding to the specular gloss is converted to obtain a converted signal. That is, the following signal is obtained: a signal corresponding to the specular gloss reproducible by the material appearance reproducing apparatus and having the smallest difference from the signal corresponding to the specular gloss obtained in step S102 while maintaining the color signal converted in step S203 and the signal corresponding to the image clarity obtained in step S305.

### Block Building

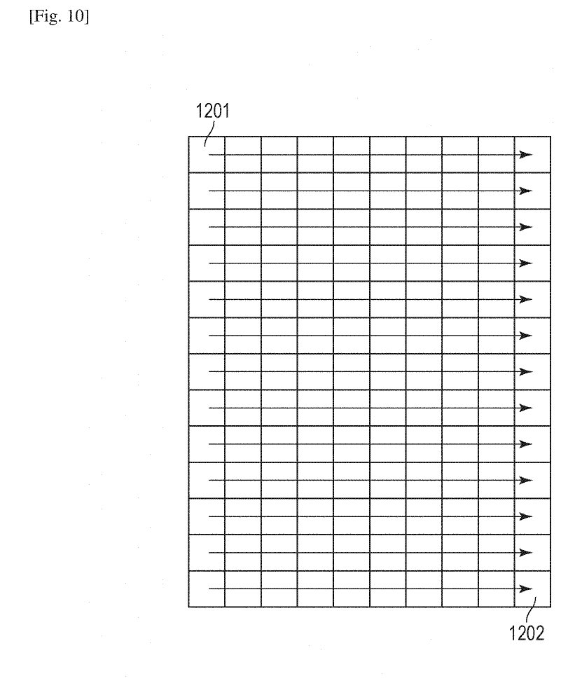

FIG. 10 is a schematic illustration of the order in which the processing areas are scanned in a block building process. Each of cells having a square shape is an area holding the material appearance signal. The processing starts from an area 1201 to another area in a direction indicated by an arrow. After the rightmost area is processed, the processing proceeds to the leftmost area in the next row. Thereafter, scanning is performed in the same manner to repeatedly process the subsequent areas until an area 1202 is reached.

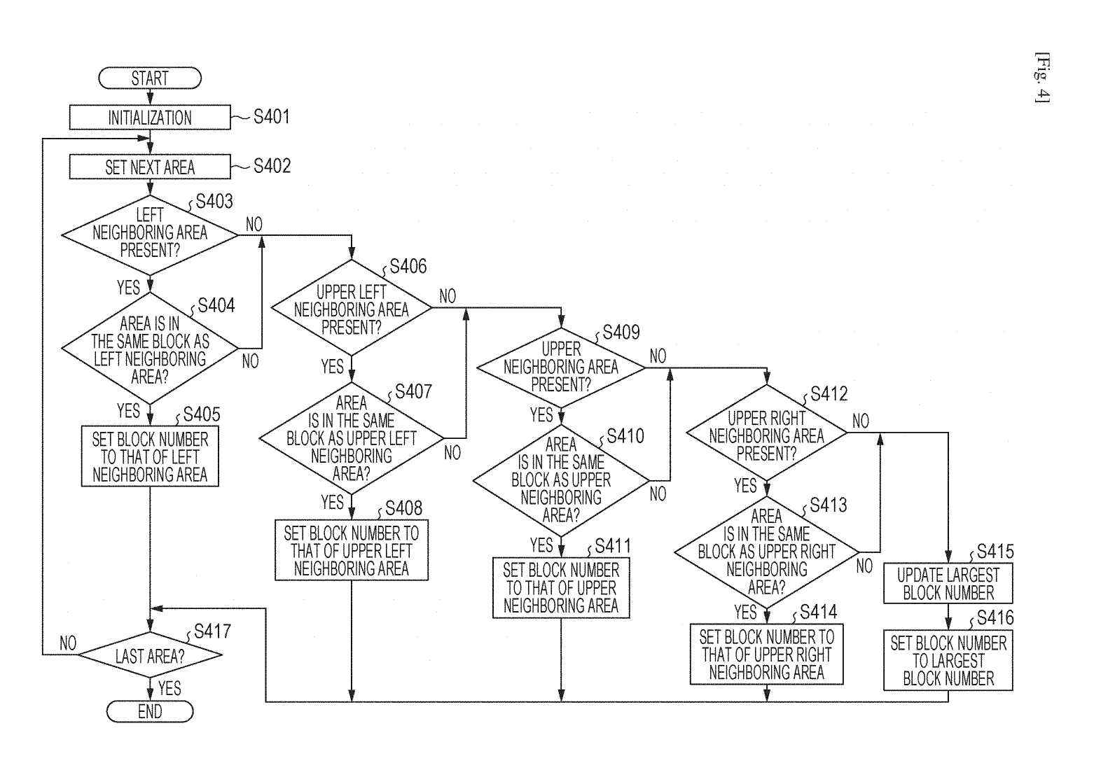

FIG. 4 is a flowchart of the steps of the first half of a block building procedure. In the first half processing, the same block number is assigned to areas each having a difference from the gloss signal of a neighboring area that is smaller than a predetermined threshold value. In step S401, an initialization process is performed. More specifically, an initial value of the largest block number is set to 1. In addition, the block number of block corresponding to a first area 1201 is set to 1. Subsequently, in step S402, the next processing area is selected on the basis of the scan order illustrated in FIG. 10. In step S403, it is determined whether an area is present to the left of the processing area. If an area is present to the left of the processing area, the processing proceeds to step S404. Otherwise, the processing proceeds to step S406. In step S404, it is determined whether the processing area is in the same block as the left neighboring area. That is, a difference in gloss between the processing area and the left area is obtained. Thereafter, it is determined whether the difference in gloss is less than the predetermined threshold value. For example, as the value of the difference in gloss, the sum of the square of the difference between gloss signals corresponding to the specular gloss and the square of the difference in gloss signals corresponding to the image clarity can he used. When the 20-degree specular gloss measured using a technique defined by JIS Z8741 is used for the gloss signal corresponding to the specular gloss and the degree of sharpness of reflected measured using a technique defined by JIS K7174 is used for the gloss signal corresponding to the image clarity, the threshold value is set to, for example, 50. If the difference in gloss is less than the threshold value, it is determined that the processing block is in the same block as the left neighboring block. Thereafter, the processing proceeds to step S405. Otherwise, the processing proceeds to step S406. In step S405, the block number of the block corresponding to the processing area is set to the block number of the block corresponding to the left neighboring area. Thereafter, the processing proceeds to step S417.

In step S406, it is determined whether an area is present to the upper left of the processing area. If an area is present, the processing proceeds to step S407. Otherwise, the processing proceeds to step S409. In step S407, it is determined whether the processing area is in the same block as the upper left neighboring area of the processing area. That is, the difference in gloss between the processing area and the upper left neighboring area is obtained, and it is determined whether the difference in gloss is less than the predetermined threshold value. The determination is made in the same manner as in step S404. If the difference in gloss is less than the threshold value, it is determined that the processing area is in the same block as the upper left neighboring area of the processing area. Thereafter, the processing proceeds to step S408. Otherwise, the processing proceeds to step S409. In step S408, the block number of the block corresponding to the processing area is set to the block number of the upper left neighboring block. Thereafter, the processing proceeds to step S417.

In step S409, it is determined whether an area is present on top of the processing area if an area is present on top of the processing area, the processing proceeds to step S410. Otherwise, the processing proceeds to step S412. In step S410, it is determined whether the processing area is in the same block as the area on top of the processing area. That is, the difference in gloss between the processing area and the area on top of the processing area is obtained, and it is determined whether the difference in gloss is less than the predetermined threshold value. The determination is made in the same manner as in step S404. If the difference in gloss is less than the threshold value, it is determined that the processing area is in the same block as the area on top of the processing area. Thereafter, the processing proceeds to step S411. Otherwise, the processing proceeds to step S412. In step S411, the block number of the block corresponding to the processing area is set to the block number of the block corresponding to the area on top of the processing area. Thereafter, the processing proceeds to step S417.

In step S412, it is determined whether area is present the upper right of processing area. If an area is present, the processing proceeds to step S413. Otherwise, the processing proceeds to step S415. In step S413, it is determined whether the processing area is in the same block as the upper right neighboring area of the processing area. That is, the difference in gloss between the processing area and the upper right neighboring area is obtained, and it is determined whether the difference in gloss is less than the predetermined threshold value. The determination is made in the same manner as in step S404. If the difference in gloss is less than the threshold value, it is determined that the processing area is in the same block as the upper right neighboring area of the processing area. Thereafter, the processing proceeds to step S414. Otherwise, the processing proceeds to step S415. In step S414, the block number of the block corresponding to the processing area is set to the block number of the upper right neighboring area. Thereafter, the processing proceeds to step S417.

In step S415, the largest block number is updated by incrementing the largest block number by one. Thereafter, the updated largest block number is set for the block corresponding to the processing area. In step S417, it is determined whether the processing area is the last area 1202. If the processing area is the last area 1202, the first half processing is completed, and the processing proceeds to the second half processing. Otherwise, the processing returns to step S402. Note that the first half of the block building process is not limited to the above-described procedure. For example, another labeling process may be employed.

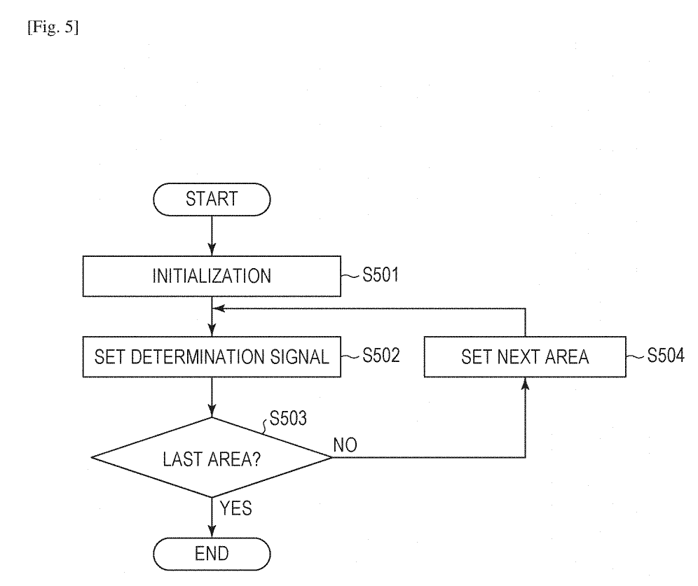

FIG. 5 is a flowchart of the steps (the processes) of the second half of the block building processing. In the second half of the block building processing, a determination signal is set for each of areas on the basis of the block number assigned to the area in the first half of the block building processing. In step S501, the first area 1201 is defined as the processing area first. Subsequently, in step S502, in a region of n (vertically)×m (horizontally) areas at the center of which there is the processing area, the number of areas each having a block number that is the same as the block number assigned to the processing area is counted. Thereafter, a value obtained by dividing the number by the product of n and m is set in the determination signal. For example, the values of n and in are determined so that the shape of a reproduced object corresponding to n (vertically)×m (horizontally) areas is a 10 mm square. In such a case, the determination signal having a value of “1” indicates that all the areas of the 10 mm square belong to the same block. The determination signal having a value of “0.5” indicates that half the areas belong to the same block. Subsequently, in step S503, it is determined whether the processing area is the last area 1202. If the processing area is the last area 1202, the processing is completed. Otherwise, the processing proceeds to step S504, where the next processing area is set on the basis of the scan order illustrated in FIG. 10. Thereafter, the processing proceeds to step S502.

### Hardware Configuration of Material Appearance Reproducing System

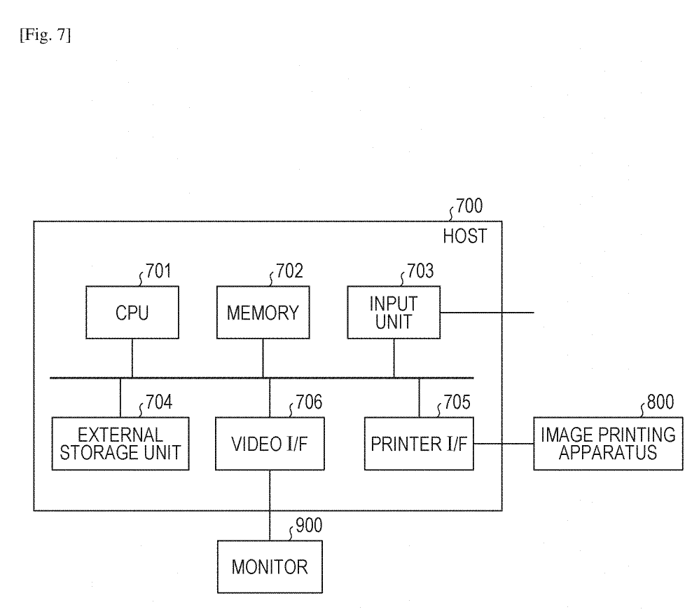

FIG. 7 a block diagram of the hardware configuration of an image printing system serving as a material appearance reproducing system. As illustrated in FIG. 7, a host 700 serving as an image processing apparatus (e.g., a computer) includes a micro-processor (a CPU) 701 and a memory 702, such as a random access memory. The host 700 further include an input unit 703, such as a keyboard, and an external storage unit 704, such as a hard disk drive. In addition, the host 700 includes a communication interface 705 (hereinafter referred to as a “printer I/F”) between the host 700 and an image printing apparatus 800 serving as the material appearance reproducing apparatus and a communication interface (hereinafter referred to as a “video I/F”) 706 between. the host 700 and a monitor 900. The CPU 701 performs a variety of processes in accordance with programs stored in the memory 702. For example, the CPU 701 performs a material appearance mapping process and a device signal conversion process related to the material appearance reproducing system. The programs are stored in the external storage unit 704 or are provided from an external apparatus (not illustrated). In addition, the host 700 outputs a variety of information items to the monitor 900 via the video I/F 706 and receives a variety of information items from the input unit 703. Furthermore, the host 700 is connected to the image printing apparatus 800 via the printer I/F 705. The host 700 sends a device signal converted through the device signal conversion process to the image printing apparatus 800 to perform printing and receives a variety of information items from the image printing apparatus 800. According to the present exemplary embodiment, the image printing apparatus 800 is an inkjet printer that prints an image using ink. Inkjet printers print an image by moving a print head to perform n main scans on the same line over a recording medium. In general, the material appearance reproducing range can be increased with increasing number of passes n. If the number of printing passes is large, the amount of ink used per printing pass decreases and, thus, the ink is accumulated on a recording medium in granular form. That is, fine irregularities are recorded on the surface of the recording medium. As a result, the gloss having a low image clarity can be reproduced. In contrast, if the number of passes used is limited and, thus, printing is performed through a small number of passes, the amount of ink used per pass increases. Accordingly, the ink forms a layer and, thus, the surface is flat and smooth. As a result, the gloss having a high image clarity can be reproduced.

### Print Head

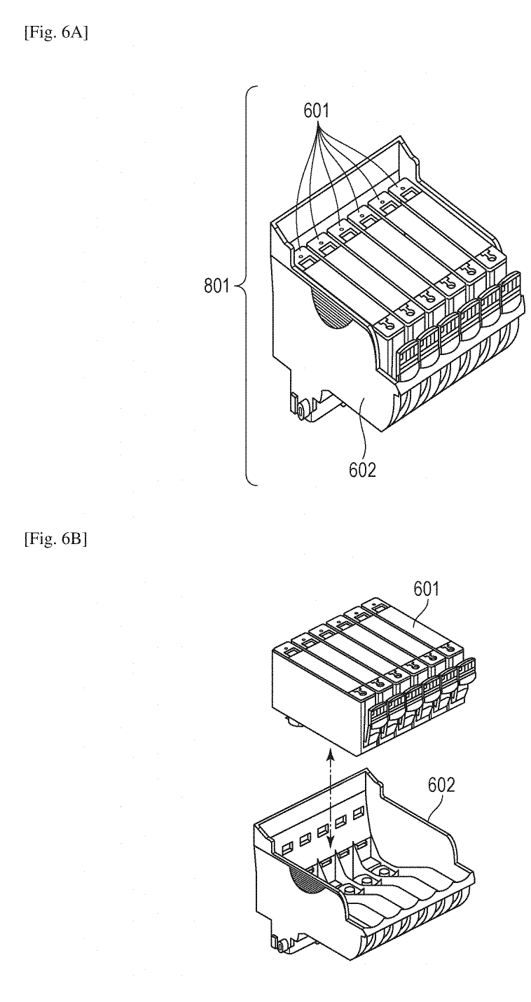

The configuration of the print head is described below. FIGS. 6A and 6B are schematic illustrations of a head cartridge 801. As illustrated in FIG. 6A, the head cartridge 801 includes an ink tank 601 that stores ink serving as a recording agent and a print head 602 that ejects ink supplied from the ink tank 601 in accordance with an ejection signal. The head cartridge 801 includes, for example, yellow (Y), magenta (M), cyan (C), black (K), gloss control agent 1 (A), and gloss control agent 2 (B) ink tanks 601, which are independent from one another. As illustrated in FIG. 6B, each of the ink tanks 601 is removable from the print head 602. The gloss control agent 1 and the gloss control agent 2 are clear and colorless ink having different indices of refraction. The index of refraction of the gloss control agent 1 is low, and the index of refraction of the gloss control agent 2 is high. An area having the gloss control agent 1, which has a high index of refraction, recorded as the topmost surface has a high reflectivity. Thus, the gloss having a high specular gloss can be reproduced. In contrast, an area having the gloss control agent 2, which has a low index of refraction, recorded as the topmost surface has a low reflectivity. Thus, the gloss having a low specular gloss can be reproduced. In addition, by controlling the ratio of an area recorded using the gloss control agent 1 to an area recorded using the gloss control agent 2, the specular gloss between those of the gloss control agent 1 and the gloss control agent 2 can be reproduced.

### Functional Configuration of Material Appearance Reproducing System 1

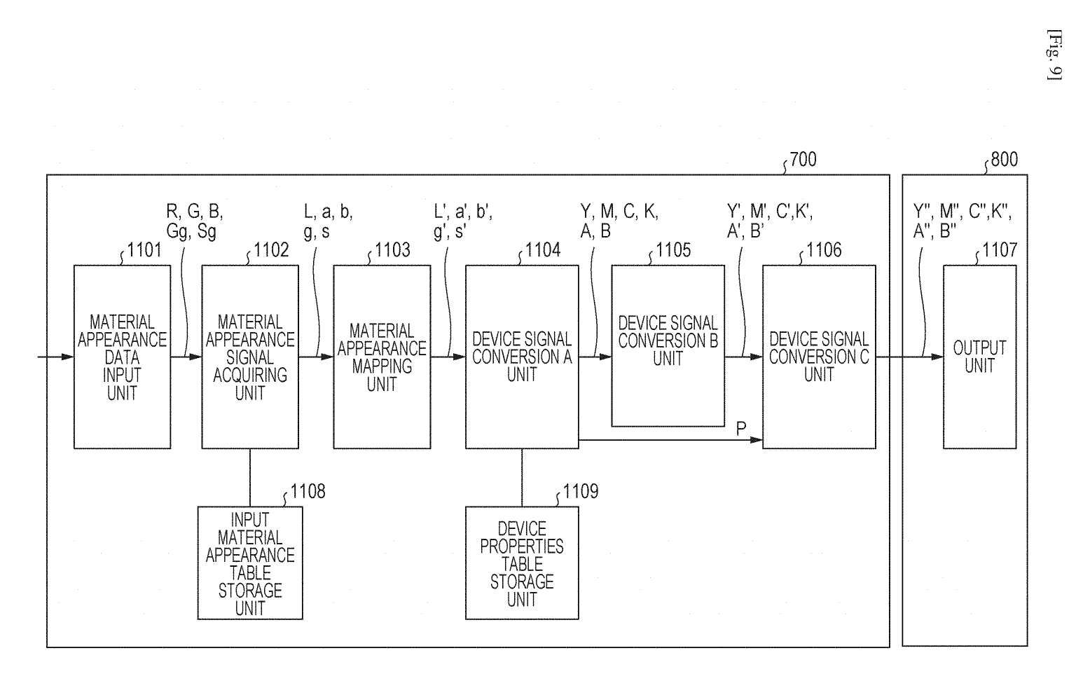

FIG. 9 is a block diagram illustrating the functional configuration of the material appearance reproducing system according to the first exemplary embodiment. The material appearance reproducing system converts input data into a material appearance signal reproducible by the material appearance reproducing apparatus using a material appearance data input unit 1101, a material appearance signal acquiring unit 1102, and a material appearance mapping unit 1103. In addition, the material appearance reproducing system prints an image serving as a reproduced object corresponding to the input data using a device signal conversion A unit 1104, a device signal conversion B unit 1105, a device signal conversion C unit 1106, and an output unit 1107. Note that in FIG. 9, the material appearance data input unit 1101, the material appearance signal acquiring unit 1102, the material appearance mapping unit 1103, the device signal conversion A unit 1104, the device signal conversion C unit 1105, and the device signal conversion C unit 1106 are achieved by the host 700. The output unit 1107 is achieved by the image printing apparatus 800 serving as the material appearance reproducing apparatus.

The material appearance data input unit 1101 receives image data in the form of a material appearance signal. The material appearance signal is formed from a color signal and a gloss signal. Each of the pixels of the image data has elements of gloss signals (Gg, Sg) in addition to widely used color signals (R, G, B). The gloss signal Gg is a signal corresponding to the specular gloss. The gloss signal Sg is a signal corresponding to the image clarity. Each of the material appearance signals (R, G, B, Gg, Sg) that constitute the image data is an 8-bit digital signal. However, the format of the input image data is not limited thereto. For example, two types of image data, that is, image data formed from a color signal and image data formed from a gloss signal, may be input to the material appearance data input unit 1101.

The material appearance signal acquiring unit 1102 converts the material appearance signals that constitute the image received by the material appearance data input unit 1101 into color signals (L, a, b) based on CIELAB, a gloss signal (g) corresponding to the specular gloss, and a gloss signal (s) corresponding to the image clarity. It is desirable that the material appearance signals (L, a, b, g, s) output from the material appearance signal acquiring unit 1102 be signals that are based on the measurement values and that do not depend on the apparatus. The conversion from the color signals (R, G, B) into the color signals (L, a, b) is performed using a standard conversion technique, such as sRGB. Alternatively, the conversion may be performed by referring to a color table stored in an input material appearance table storage unit 1108 and using a widely used three-dimensional lookup table technique. The color table contains the relationship between the color signals (R, G, B) and the color signals (L, a, b). The conversion from the gloss signal (Gg) corresponding to the specular gloss into the gloss signal (g) and the conversion from the gloss signal (Sg) corresponding to the image clarity into the gloss signal (s) are performed by referring to a gloss table stored in the input material appearance table storage unit 1108 and using a widely used lookup table technique. The gloss table contains the correspondence between a gloss signal (Gg) and a gloss signal (g) and the correspondence between a gloss signal (Sg) and a gloss signal (s). Preferably, the color table and the gloss table are provided for each of the type of image data and each of the material appearance acquiring apparatuses that generate input image data in advance and are selected in accordance with the image data received by the material appearance data input unit 1101. Alternatively, the color table and the gloss table may be selected in accordance with a user instruction.

The material appearance mapping unit 1103 converts the material appearance signals (L, a, b, g, s) obtained by the material appearance signal acquiring unit 1102 into material appearance signals (L′, a′, b′, g′, s′) each corresponding to the material appearance reproducible by the image printing apparatus 800 through the above-described color mapping and gloss mapping.

### Color Separation Process

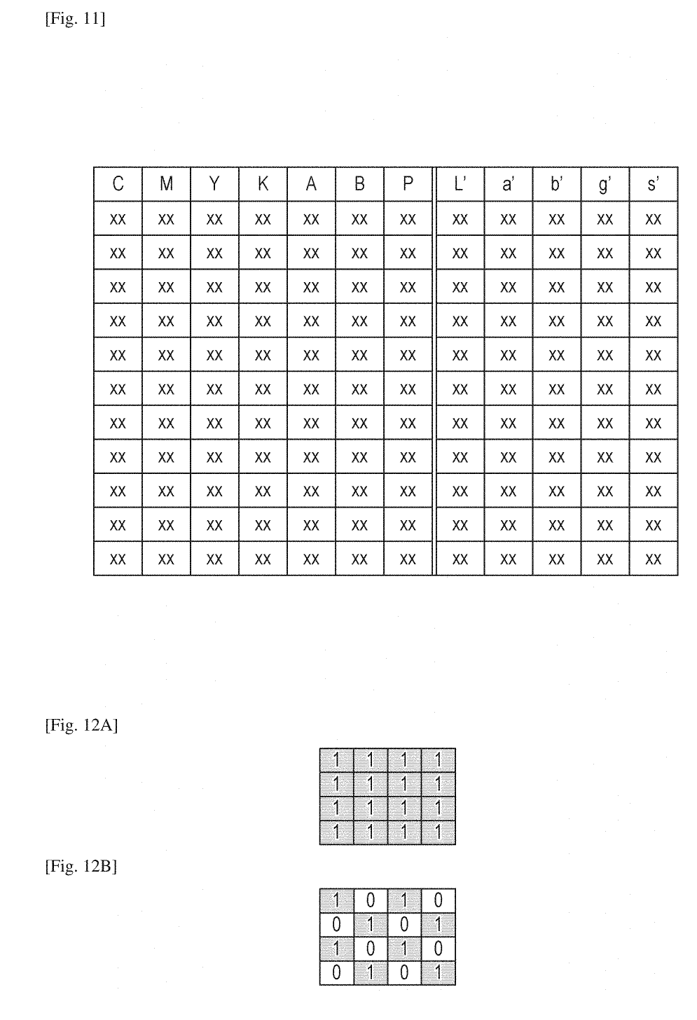

The device signal conversion A unit 1104 converts the material appearance signals (L′, a′, b′, g′, s′) into a control signal including color material amount signals (C, M, Y, K), gloss control agent amount signals (A, B), and a pass control signal (P) of the image printing apparatus 800. The conversion is performed by referring to a device properties table stored in a device properties table storage unit 1109 and using a widely used n-dimensional lookup table technique. FIG. 11 is a schematic illustration of an example of the device properties table. As illustrated in FIG. 11, the device properties table contains the values of material appearance signals (L′, a′, b′, g′, s′) corresponding to discrete control signals (C, M, Y, K, A, B, P). The color material amount signals (C, M, Y, K) are signals related to the amounts of yellow, magenta, cyan, and black color materials, respectively. For example, each of the color material amount signals is an 8-bit digital signal. The gloss control agent amount signals (A, B) indicate the amounts of the gloss control agent 1 and the gloss control agent 2, respectively. For example, each of the gloss control agent amount signals is an 8-bit digital signal. The pass control signal (P) indicates the number of printing passes, which is in the range from, for example, 1 to 16. If the signal value is 1, one-pass printing is selected. If the signal value is 16, 16-pass printing is selected.

### Halftone Process

The device signal conversion B unit 1105 performs a halftone process on the control signals (C, M, Y, K, A, B) converted by the device signal conversion A unit 1104 and converts the control signals (C, M, Y, K, A, B) into binary signals (C′, M′, Y′, K′, A′, B′), respectively, each indicating whether a dot is printed or not. Each of the binary signals (C′, M′, Y′, K′, A′, B′) indicates the dot print position. For example, a dot is printed at a position having a signal value of “1” and is not printed at a position having a signal value of “0”. To perform the halftone process, a widely used error diffusion technique or systematic dither technique.

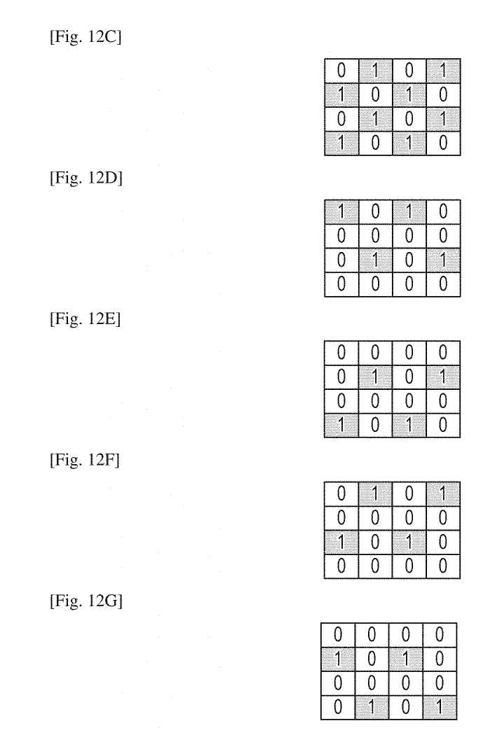

The device signal conversion C unit 1106 performs a pass separation process on the basis of the control signal (P) related to the number of passes and the control signals (C′, M′, Y′, K′, A′, B′) related to the dot patterns of the color materials and the gloss control material. In the pass separation process, the logical OR of a pass mask and the control signals (C, M′, Y′, K′, A′, B′) is calculated, and control signals (C″, M″, Y″, K″, A″, B″) related to the dot pattern printed in each pass are generated. According to the first exemplary embodiment, the material appearance reproducing system has 16 sets of pass mask (for 1-pass printing to 16-pass printing). One of the sets of pass mask is selected in accordance with the value P and is used. For example, if the value of P is 2 indicating 2-pass printing, the cyan dot pattern for the first pass is generated by the logical OR of the pass mask for a first pass of the 2-pass printing pass mask set and the control signal C′ indicating the cyan dot print positions. FIGS. 12A to 12G are schematic illustrations of examples of the pass mask. FIG. 12A illustrates a pass mask for a first pass of 1-pass printing. In 1-pass printing, all the dots are printed in the first pass. FIGS. 12B and 12C illustrate the pass masks for a first pass and a second pass of 2-pass printing, respectively. In 2-pass printing, the dots are separated into the dots for the first pass and the dots for the second pass and are printed. FIGS. 12D to 12G illustrate the pass masks for first to fourth passes of 4-pass printing, respectively. In 4-pass printing, the dots are separated into the dots for four passes, that is, the first to fourth passes and are printed. Similarly, in n-pass printing, the dots are separated into the dots for n passes, that is, the first to n-th passes and are printed. According to the device signal conversion C unit 1106 of the material appearance reproducing system of the first exemplary embodiment, by controlling the number of printing passes for each of the pixels, the shape of the surface can be controlled in accordance with the number of passes and, thus, the image clarity of each of the pixels can be controlled. Note that different pass masks may be provided in accordance with the types of ink.

The output unit 1107 ejects each of the color materials and each of the gloss control agents on the basis of the dot pattern data generated by the device signal conversion C unit 1106. In this manner, an image representing a material appearance reproduced object is formed on a recording medium.

In the above-described material appearance reproducing procedure, the processes in steps S101 to S103 are performed by the material appearance data input unit 1101, the material appearance signal acquiring unit 1102, and the material appearance mapping unit 1103, respectively. In addition, the process in step S104 is performed by the device signal conversion A unit 1104, the device signal conversion B unit 1105, and the device signal conversion C unit 1106. Furthermore the process in step S105 is performed by the output unit 1107.

As described above, according to the first exemplary embodiment, the material appearance reproducing system performs the material appearance mapping to convert the input data into the material appearance data corresponding to the material appearance reproducible by the material appearance reproducing apparatus. In the material appearance mapping, the color signal and the gloss signal are converted so that the colors, the specular gloss, and the image clarity indicated by the input data are mapped to a combination of the colors, the specular gloss, and the image clarity reproducible by the material appearance reproducing apparatus. In this manner, even when the combination of the colors, the specular gloss, and the image clarity indicated by the input data is not reproducible by the material appearance reproducing apparatus, the reproduced object can be output by the material appearance reproducing apparatus.

In addition, in the material appearance mapping performed by the material appearance reproducing system according to the first exemplary embodiment, unlike an area having a small change in gloss, the reproducibility of the specular gloss is given more weight in an area having a large change in gloss. That is, when a specular gloss error is defined as a difference between the specular gloss indicated by the input data and the specular gloss of a reproduced object, the gloss signal is converted as follows. That is, the gloss signal is converted so that the specular gloss error in an area having a relatively large change in gloss is lower than the specular gloss error in an area having a relatively small change in gloss. In this manner, for example, a granular area that glitters can be excellently reproduced.

In addition, in the material appearance mapping performed by the material appearance reproducing system according to the first exemplary embodiment, unlike an area having a large change in gloss, the reproducibility of the image clarity is given more weight in an area having a small change in gloss. That is, when an image clarity error is defined as a difference between the image clarity indicated by the input data and the image clarity of a reproduced object, the gloss signal is converted as follows. That is, the gloss signal is converted so that the image clarity error in an area having a relatively small change in gloss is lower than the image clarity error in an area having a relatively large change in gloss. In this manner, for example, an area in which the substantially uniform gloss is widely distributed and an area in which gently changing gloss is widely distributed can be excellently reproduced.

In addition, according to the first exemplary embodiment, the material appearance reproducing system converts the input material appearance data into a signal value that is reproducible by the material appearance reproducing apparatus in a space having at least axes of the specular gloss and the image clarity. In this manner, for example, two types of gloss having the same specular gloss and different image clarifies can be recognized as different types of gloss and, thus, the appearance of the object to be reproduced indicated by the input data can be made to be the same as the appearance of the reproduced object.

### First Modification 1

According to the material appearance reproducing system of the first exemplary embodiment, the size of a block to which areas belong is used as a determination signal, and one of the process in which the reproducibility of the image clarity is given more weight and the process in which the reproducibility of the specular gloss is given more weight is selected. In first modification, another index is used as the determination signal. The first modification is described below.

### Gloss Mapping Process

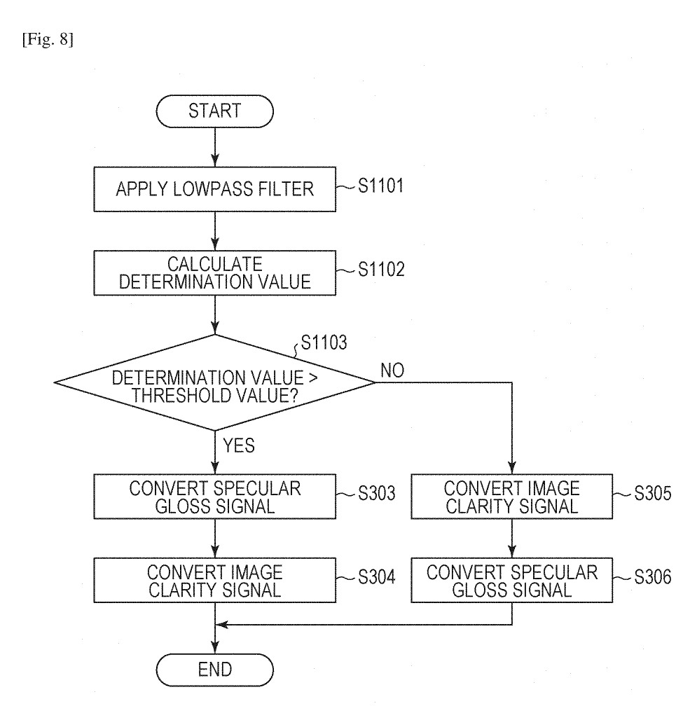

FIG. 8 is a flowchart of the steps (the processes) of a gloss mapping procedure according to a first modification. FIG. 8 illustrates the details of the process in step S204 illustrated in FIG. 2. In step S1101, a lowpass filter is applied to the spatial distribution of the material appearance signals first. For example, on the basis of the sampling theorem, the lowpass filter that makes the response to 1 cycle/mm be a half the response to 0.05 cycle/mm is applied to the two-dimensional distribution of the gloss signal corresponding to the specular gloss and the two-dimensional distribution of the gloss signal corresponding to the image clarity. Subsequently, in step S1102, a determination signal that corresponds to a difference between the gloss signals before and after application of the lowpass filter is calculated. For example, the sum of the square of the difference between the gloss signals corresponding to the specular gloss and the square of the difference between the gloss signals corresponding to the image clarity is used as the determination signal. Subsequently, in step S1103, it is determined whether the determination signal obtained in step S1102 is higher than a predetermined threshold value. For example, the threshold value is set to 50 if the 20-degree specular gloss measured using an existing technique is used as the gloss signal corresponding to the specular gloss and the image clarity measured using an existing technique is used as the gloss signal corresponding to the image clarity. If the determination value of the area of interest is greater than the threshold value, it is determined that the area of interest has a large gloss change and, thus, the processing proceeds to step S303. Otherwise, it is determined that the area of interest has a small gloss change and, thus, the processing proceeds to step S305.

As described above, according to the material appearance reproducing system of the first modification, a gloss distribution is generated by applying a lowpass filter to the spatial distribution of the material appearance signals, and the difference between the gloss signals for the area of interest before and after application of the lowpass filter is used as the determination signal. A large determination signal indicates that the area of interest has a large gloss change, and a small determination signal indicates that the area of interest has a small gloss change. In this manner, the material appearance reproducing apparatus can distinguish between an area having a large gloss change and an area having a small gloss change. Since fast Fourier transform (FFT) that can provide high-speed calculation can be employed in the lowpass process, the process can be performed at high speed.

In general, to distinguish between an area having a large gloss change and an area having a small gloss change, the value regarding the amplitude or the cycle of a gloss change can be used. As used herein, the term “amplitude” refers to a value related to a difference between gloss signals. A large amplitude of a gloss change indicates that a difference between the gloss signal of the area of interest and the gloss signal of an area in the vicinity of the area of interest is large. As used herein, the term “cycle” refers to a value related to spatial breadth or the size of an area. A long cycle of a gloss change indicates that a region having a level of the gloss signal that is substantially the same as the level of the gloss signal of the area of interest is widely distributed so as to be adjacent to the area of interest. If the determination signal indicates a value related to the amplitude of a gloss change, a larger determination signal indicates a larger gloss change. In contrast, if the determination signal indicates a value related to the cycle of a gloss change, a larger determination signal indicates a smaller gloss change. According to the first exemplary embodiment, the determination signal is a value related to the cycle of a gloss change. In contrast, according to the first modification, the determination signal is a value related to the amplitude of the gloss change. Note that the amplitude and the cycle of the gloss change can be acquired from the spatial distribution of the material appearance signals.

### Other Modifications 1

The determination signal may be a combination of a value related to the amplitude of a gloss change and the cycle of the gloss change. If the results of determination of the two types are not the same, the result for the determination signal having a high priority may be selected, for example. The priority may be assigned in advance, or may be assigned in accordance with the type of object to be reproduced, the type of recording medium, or a user instruction.

The gloss signal corresponding to the specular gloss need not be limited to a value measured under the standard conditions, but may be a value measured under other conditions or a function of the value. For example, the direction of illumination in the measurement may be at 30 degrees. In addition, the angles of aperture of illumination and received light are not limited to those under the standard conditions. Furthermore, the signal corresponding to the specular gloss may contain color information in addition to the brightness information. For example, as a signal containing color information, a CIELAB value calculated using JIS Z8722 after measuring the amount of specular reflection light can he used. Thereafter, as the gloss signal corresponding to the specular gloss, three signals gL, ga, and gb are used instead of the signal g. In such a case, a signal corresponding to the specular gloss in the gloss mapping is converted in a three-dimensional color space. To convert the signal, an existing color matching technique can be used, as in the conversion of the color signal.

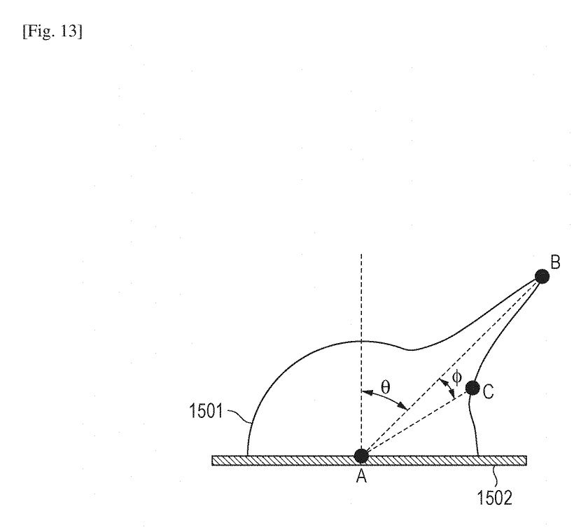

In addition, the gloss signal corresponding to the image clarity is not limited to a value measured under the standard conditions. A value measured under other conditions or a function of the value may be used. For example, an angle φ formed by a direction in which the amount of reflection light is half the amount of the specular reflection light in the vicinity of the specular direction and the specular direction is measured, and the inverse function of the angle φ may be used. FIG. 13 is a schematic illustration of typical characteristics of multi angle distribution of reflection. In FIG. 13, a line 1501 represents the amount of reflection light reflected from a point A of a sample 1502. The direction of an angle θ in which the amount of reflection light is large is the specular direction of the illumination direction. The length of a line segment AB indicates the amount of reflection light in the specular direction. A point C is a midpoint at which the length of a line segment AC is half the length of the line segment AB. The angle formed by the line segment AB and the line segment AC is the angle φ. For samples having a large image clarity, the light diffusion toward the vicinity of the specular direction is small and, thus, the angle φ is small. In contrast, for samples having a small image clarity, the angle φ is large.

In addition, as the gloss signal corresponding to the image clarity, the measurement value of the surface regularities or a function of the measurement value may be used. An object to be reproduced having a smooth surface, that is, small surface regularities has a large image clarity. An object to be reproduced having large surface regularities has a small image clarity.

In addition, the gloss signal may contain an element related to the normal direction of each of the areas. For some objects to be reproduced, the normal direction may vary from area to area. In such a case, to obtain a reproduced object having an appearance that is the same as the appearance of the object to be reproduced, information regarding the normal direction is needed in addition to the specular gloss and the image clarity as the information held by each area. The normal direction can be reproduced by controlling the surface regularities. The surface regularities can be printed by using, for example, a UV inkjet printer or a 3D printer. In addition, if the gloss signal has the element related to the normal direction, an element related to the difference in the normal direction is set in the gloss signal in addition to the difference in the specular gloss and the difference in the image clarity in order to calculate the gloss difference from an area in the vicinity. That is, the gloss difference used in steps S404, S407, S410, and S413 illustrated in FIG. 4 (in the block building procedure according to the first exemplary embodiment) is changed to, for example, the sum of squares of the difference between gloss signals corresponding to the specular gloss, the difference between gloss signals corresponding to the image clarity, and the difference between gloss signals corresponding to the normal direction. Similarly, the determination signal obtained in step S1002 illustrated in FIG. 8 (in the gloss mapping procedure according to the present exemplary embodiment) is changed to, for example, the sum of squares of the difference between gloss signals corresponding to the specular gloss, the difference between gloss signals corresponding to the image clarity, and the difference between gloss signals corresponding to the normal direction. In this manner, for the areas having a large change in the normal direction, the specular gloss is given more weight over the image clarity and, thus, the appearance of the object to be reproduced can be made to be more similar to the appearance of the reproduced object.

The technique for evaluating the gloss difference is also only an example. Another evaluation technique can be employed. For example, the difference in the specular gloss and the difference in the image clarity may be independently obtained. A threshold value may be set for each of the differences. If one of the differences is greater than the threshold value, it can be determined that the gloss difference is large.

The above-described threshold value is only an example. The threshold value is not limited to the value described in the above-described exemplary embodiment. The threshold value may be determined on the basis of the type of recording medium, the type of object that constitutes the material appearance data, or a user instruction.

### Second Exemplary Embodiment

According to the present exemplary embodiment, a configuration in which input data is directly converted into the control signal for controlling the material appearance reproducing apparatus is described. Note that the same numbering will be used in describing the configuration of the present exemplary embodiment as was utilized above in describing the first exemplary embodiment, and description of the same configuration is not repeated.

### Functional Configuration of Material Appearance Reproducing System 2

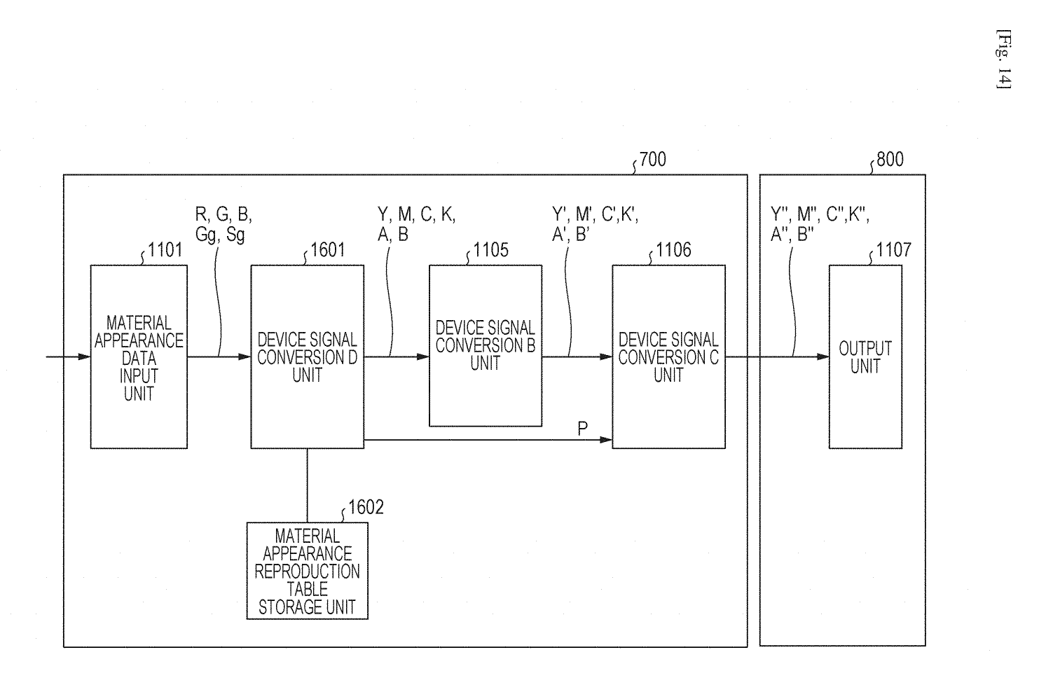

FIG. 14 is a block diagram of the functional configuration of a material appearance reproducing system according to the second exemplary embodiment. The material appearance reproducing system prints an image serving as a reproduced object on a recording medium using a material appearance data input unit 1101, a device signal conversion D unit 1601, a device signal conversion B unit 1105, a device signal conversion C unit 1106, and an output unit 1107. Note that in FIG. 14, the material appearance data input unit 1101, the device signal conversion D unit 1601, the device signal conversion B unit 1105, and the device signal conversion C unit 1106 are achieved by a host 700. The output unit 1107 is achieved by an image printing apparatus 800 serving as the material appearance reproducing apparatus.

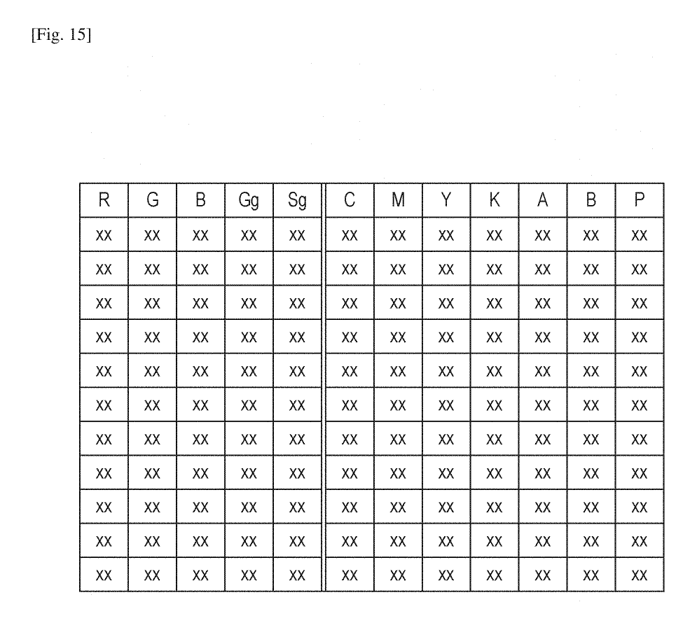

The device signal conversion D unit 1601 converts material appearance signals (R, G, B, Gg, Sg) that constitute the image data received by the material appearance data input unit 1101 into a control signal including color material amount signals (C, M, Y, K), gloss control agent amount signals (A, B), and a pass control signal (P) of the image printing apparatus 800. The conversion is performed by referring to a material appearance reproduction table stored in a material appearance reproduction table storage unit 1602 and using a widely used n-dimensional lookup table technique. FIG. 15 is a schematic illustration of an example of the material appearance reproduction table. As illustrated in FIG. 15, the material appearance reproduction table contains the values of the control signals (C, M, Y, K, A, B, P) corresponding to discrete material appearance signals (R, G, B, Gg, Sg). Two types of table, that is, a table in which the reproducibility of the specular gloss is given more weight and a table in which the reproducibility of the image clarity is given more weight are provided. It is determined which one of the reproducibility of the specular gloss and the reproducibility of the image clarity is given more weight for each of the areas, and the table corresponding to the result of determination is referred to. The tables can be generated by the material appearance signal acquiring unit 1102, the material appearance mapping unit 1103, and the device signal conversion A unit 1104 according to the above-described first exemplary embodiment. That is, the material appearance signal acquiring unit 1102 converts the discrete material appearance signals (R, G, B, Gg, Sg) into material appearance signals (L, a, b, g, s) that do not depend on apparatuses first. Subsequently, the material appearance mapping unit 1103 converts the material appearance signal (L, a, b, g, s) into the material appearance signals (L′, b′, g′, s′) corresponding to the material appearance reproducible by the image printing apparatus 800 for each of the case in which the reproducibility of the specular gloss is given more weight and the case in which the reproducibility of the image clarity is given more weight. Thereafter, the device signal conversion A unit 1104 converts the material appearance signals into the control signals (C, M, Y, K, A, B, P) for controlling the image printing apparatus 800. The result of conversion is stored in the material appearance reproduction table.

### Material Appearance Reproducing Technique 2

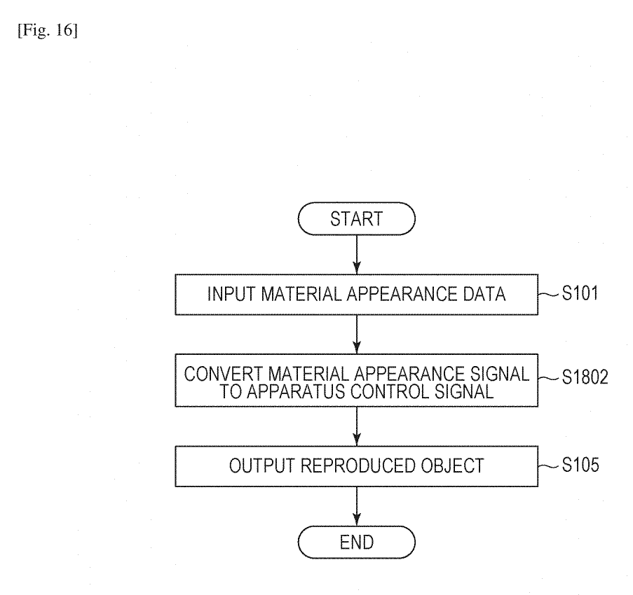

FIG. 16 is a flowchart of the steps (the processes) of the material appearance reproducing procedure according to the second exemplary embodiment. In step S101, the material appearance data to be reproduced is input first. Subsequently, in step S1802, the material appearance data input in step S101 is converted into the control signals for controlling the material appearance reproducing apparatus. Subsequently, in step S105, a reproduced object is output on the basis of the control signals converted in step S1802. The process in step S1802 is performed by the device signal conversion D unit 1601.

### First Verification Technique

A technique for verifying whether the control signals (C. M, Y, K, A, B, P) that are set in the material appearance reproduction table so as to correspond to material appearance signals (R, G, B, G, S) are suitable is described below.

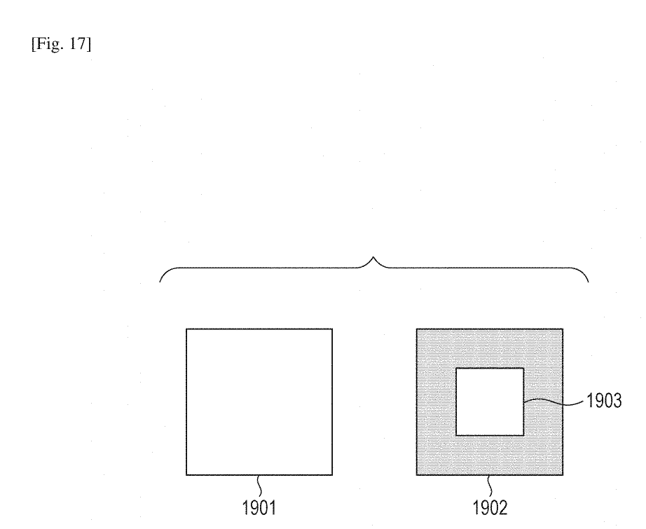

FIG. 17 is a schematic illustration of material appearance data used for describing an example of the verification technique. Material appearance data 1901 is formed from a single material appearance signal for all the areas. The material appearance data is material appearance data corresponding to the specular gloss and the image clarity unreproducible by the material appearance reproducing apparatus. Let Dorg denote the specular gloss of the material appearance data. Material appearance data 1902 is formed from an area 1903 located at the center and two areas on the outer side of the area 1903. The area 1903 located at the center of the material appearance data 1902 is formed from the material appearance signal that is the same as the material appearance signal of the material appearance data 1901. The areas on the outer side of the area 1903 are formed form a single material appearance signal different from that of the area 1903. The material appearance signal of the area 1903 and the material appearance signal of the areas located on the outer side of the area 1903 are set so that the gloss signals sufficiently differ from each other. In addition, setting is made so that the sizes of the material appearance data 1901 and the material appearance data 1902 are the same, the size of the material appearance data 1901 is sufficiently large, and the size of the area 1903 is sufficiently small. By appropriately setting these parameters, material appearance data can be configured such that the center portion of the material appearance data 1901 is determined to be an area having a small gloss change and the area 1903 is determined to be an area having a large gloss change. For example, each of the sizes of the material appearance data 1901 and the material appearance data 1902 is greater than or equal to 20 mm square, and the size of the area 1903 is less than or equal to 10 mm square.

The material appearance data 1901 is input to the material appearance reproducing system according to the present exemplary embodiment. The material appearance reproducing apparatus outputs the reproduced object. In this manner, the reproduced object can be obtained. Let Dout1 denote the value obtained by measuring the specular gloss of the reproduced object using a technique defined in JIS Z8741. In the same manner, the material appearance data 1902 is input to the material appearance reproducing system according to the present exemplary embodiment, and the material appearance reproducing apparatus outputs the reproduced object. In this manner, the reproduced object is obtained. Let Dout2 denote the measurement value of the specular gloss of the area corresponding to the area 1903 of the reproduced object. To remove the adverse effect of a variation of the material appearance reproducing apparatus, the average of the specular gloss values of a plurality of reproduced objects may be used for the values of Dout1 and Dout2.

If the material appearance reproduction table is appropriately set, the reproducibility of the specular gloss is given more weight in an area having a large gloss change than in an area having a small gloss change. Accordingly, the difference between the specular gloss indicated by the material appearance data and the specular gloss of the reproduced object is small. That is, if the absolute value of (Dorg-Dout2) is less than the absolute value of (Dorg-Dout1), it is determined that the material appearance reproduction table is appropriate. However, if the absolute value of (Dorg-Dout2) cannot be less than the absolute value of (Dorg-Dout1) in any setting of the parameters of the material appearance data 1901 and the material appearance data 1907, it is determined that the material appearance reproduction table is inappropriate.

According to the above-described technique, a process in which the reproducibility of the image clarity is given more weight and a process in which the reproducibility of the specular gloss is given more weight are reliably switched in accordance with the spatial distribution of the material appearance signals so that the difference between the appearances becomes smaller.

As described above, the material appearance reproducing system according to the second exemplary embodiment refers to the material appearance reproduction table describing a correspondence between a discrete material appearance signal and the control signal for controlling the material appearance reproducing apparatus and performs the processes that are performed by the units of the first exemplary embodiment through only a single conversion process. That is, the processes performed by the material appearance signal acquiring unit 1102, the material appearance mapping unit 1103, and the device signal conversion A unit 1104 of the first exemplary embodiment are performed as a single conversion process.

### Third Exemplary Embodiment

When a user of the material appearance reproducing apparatus wants to adjust the material appearance of a reproduced object into desired material appearance, it is difficult to freely adjust the distribution of the material appearance signal. According to the present exemplary embodiment, the user adjusts an input image instead of the material appearance reproducing apparatus. In such a case, the user does not know which adjustment operation to perform on the input image to obtain desired material appearance. Accordingly, the user tends to repeatedly attempt the adjustment operation. According to the third exemplary embodiment, a configuration including a material appearance adjustment unit is provided. Note that the same numbering will be used in describing the configuration of the present exemplary embodiment as was utilized above in describing the first exemplary embodiment, and description of the same configuration is not repeated.

### Material Appearance Reproducing Technique 3

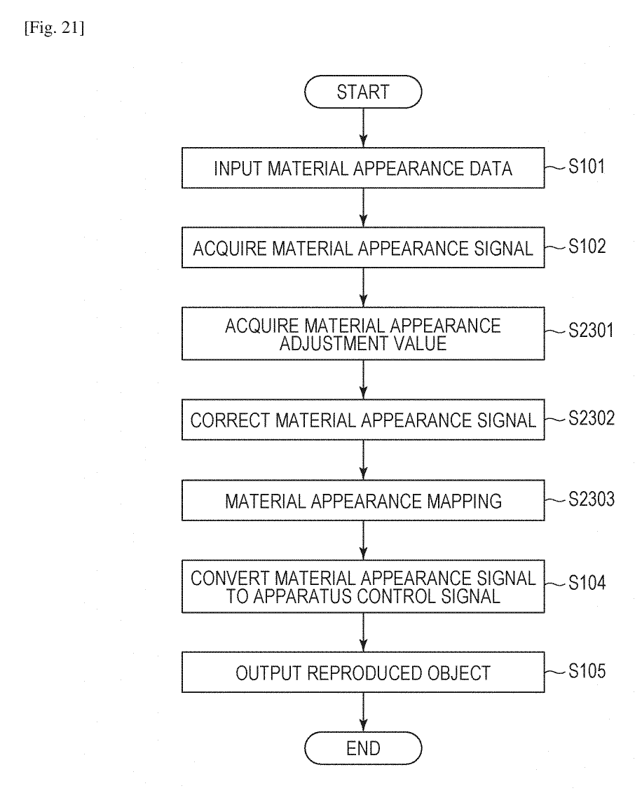

FIG. 21 a flowchart of the steps of the material appearance reproducing procedure according to the third exemplary embodiment. According to a material appearance reproducing apparatus of the third exemplary embodiment, in step S101, the material appearance data to be reproduced is input. In step S102, the material appearance signal is obtained. Thereafter, in step S2301, a material appearance adjustment value is obtained. The material appearance adjustment value serves as control information used to control the output of the material appearance reproducing apparatus to exhibit desired material appearance. According to the present exemplary embodiment, the material appearance reproducing system obtains the gloss adjustment values related to the specular gloss and the image clarity in addition to the color adjustment values.

The color adjustment value is formed from a brightness adjustment value ΔL and color adjustment values Δa and Δb. The value ΔL corresponds to L* defined in CIELAB. To perform control so that the reproduced object is brighter, the value ΔL is set to a larger positive value. In contrast, to perform control so that the reproduced object is darker, the value ΔL is set to a smaller negative value. The value Δa corresponds to a* defined in CIELAB. To perform control so that the red components of the reproduced object increase, the value Δa is set to a larger positive value. In contrast, to perform control so that the green components of the reproduced object increase, the value Δa is set to a smaller negative value. Similarly, the value Δb corresponds to b* defined in CIELAB. To perform control so that the yellow components of the reproduced object increase, the value Δb is set to a larger positive value. In contrast, to perform control so that the blue components of the reproduced object increase, the value Δb is set to a smaller negative value. A user interface (hereinafter simply referred to as a “UI”) may include a slide bar to acquire the adjustment values. In addition, for example, a slide bar for controlling the brightness has the displayed text “DARK” on one end and the display text “BRIGHT” on the other end. Thus, the user can intuitively set the adjustment value.

The adjustment value of the gloss is formed from an adjustment value Δg of the specular gloss and an adjustment value Δs of the image clarity. To perform control so that the specular gloss increases, a larger positive value Δg is set. In contrast, to perform control so that the specular gloss decreases, a smaller negative value Δg is set. Similarly, to perform control so that the image clarity increases, a larger positive value Δs is set. In contrast, to perform control so that the image clarity decreases, a smaller negative value Δs is set. A UI for acquiring the adjustment values of the gloss displays the images of the illumination light source (hereinafter also referred to as “illumination images”, which represent the appearance of the images produced by reflection at a surface of an object. Thus, the user can intuitively set the adjustment values.

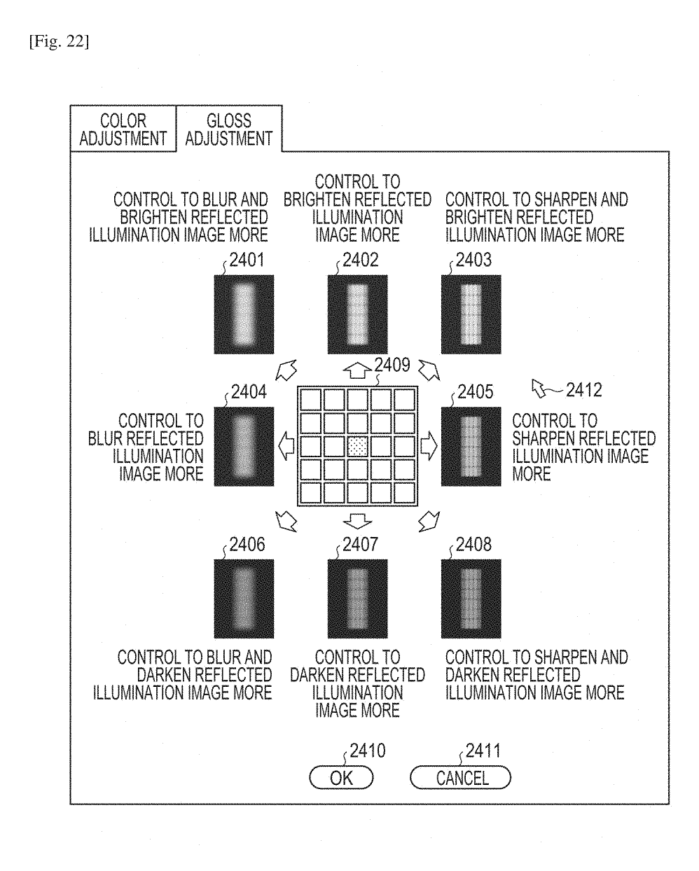

FIG. 22 is a schematic illustration of an example of a gloss adjustment UI. Images 2401 to 2408 are images of the illumination light source. In the illumination images 2401 to 2403, the illumination light source is displayed so as to be brighter than in the illumination images 2404 and 2405. In contrast, in the illumination images 2406 to 2408, the illumination light source is displayed so as to be darker than in the illumination images 2404 and 2405. These images of the illumination light source indicate the degree of the specular gloss and the degree of the image clarity thereof and indicate the pseudo images of the illumination light source produced by reflection at a surface of the reproduced object. The images 2401 to 2403 displayed in the upper section indicate the effects obtained when the specular gloss is largely controlled. The images 2406 to 2408 displayed in the lower section indicate the effects obtained when the specular gloss is slightly controlled. In addition, in the images 2403, 2405, and 2408, the illumination light source is more sharply displayed than in the images 2402 and 2407. In the images 2401, 2404, and 2406, the illumination light source is displayed so as to be more blurred than in the images 2402 and 2407. The images 2403, 2405, and 2408 displayed in the right section indicate the effects when the image clarity is largely controlled, and the images 2401, 2404, and 2406 displayed on the left section indicate the effects when the image clarity is slightly controlled. Cells 2409 form a five (vertically) by five (horizontally) matrix. The cell at the center is assigned “0”, which indicates that the adjustment value Δg of the specular gloss and the adjustment value Δs of the image clarity are not changed. In addition, for each of the other cells, an adjustment value determined in accordance with the distance between the illumination image displayed at a position in the same direction from the center cell and the center cell is assigned. That is, a cell located at a higher position is assigned a larger positive value Δg, and a cell located at a lower position is assigned a smaller negative value Δg. In addition., a cell located more rightward is assigned a larger positive value Δs, and a cell located more leftward is assigned a smaller negative value Δs. Any one of the cells is selected by the user who operates a mouse pointer 2412 and, thus, the adjustment value assigned to the cell is tentatively selected. At that time, an OK button 2410 is enabled. Subsequently, if the user selects the OK button 2410, the adjustment value is finally set to the tentatively set value. However, if a cancel button 2411 is selected, each of the adjustment values Δg and Δs is set to “0”, which indicates that no adjustment is performed.

Subsequently, in step S2302, the material appearance signals obtained in step S102 is corrected using the adjustment values obtained in step S2301. That is, adjusted material appearance signals L_a, a_a, b_a, g_a, and s_a are calculated as follows:

L_a=L+ΔL (1),

a_a=a+Δa (2),

b_a=b+Δb (3)

g_a=g+Δg (4), and

s_a=s+Δs (5),

Subsequently, in step S2303, the material appearance signals adjusted in step S2302 are converted into the material appearance signals corresponding to the material appearance reproducible by the image printing apparatus 800 serving as the material appearance reproducing apparatus using the above-described color mapping and gloss mapping.

Subsequently, in step S104, the material appearance signals converted in step S2303 are converted into the control signal for controlling the material appearance reproducing apparatus. Finally, in step S105, a reproduced object is output by the material appearance reproducing apparatus on the basis of the control signal obtained in step S104.

### Functional Configuration of Material Appearance Reproducing System 3

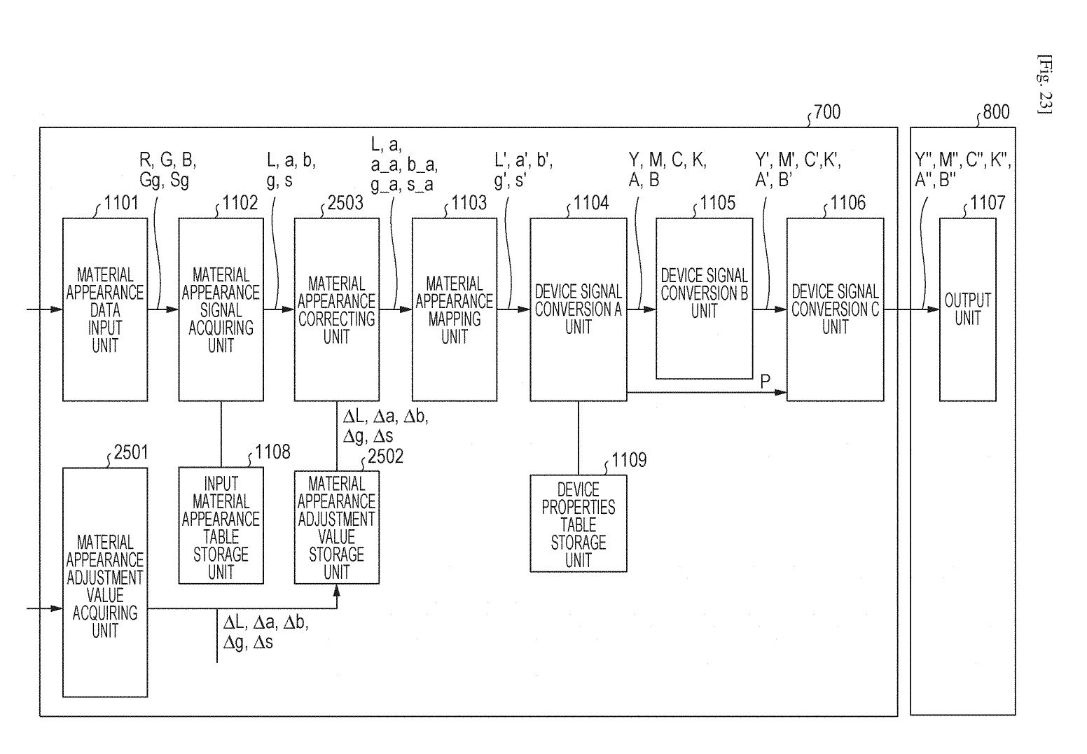

FIG. 23 is a block diagram of the functional configuration of a material appearance reproducing system according to the third exemplary embodiment. The material appearance reproducing system includes a material appearance adjustment value acquiring unit 2501, a material appearance adjustment value storage unit 2502, and a material appearance correcting unit 2503 in addition to the configuration of the material appearance reproducing system according to the first exemplary embodiment. The material appearance adjustment value acquiring unit 2501 performs the above-described process in step S2301. The material appearance adjustment value acquiring unit 2501 acquires the material appearance adjustment values (ΔL, Δa, Δb, Δg, Δs) and stores the material appearance adjustment values in the material appearance adjustment value storage unit 2502. The adjustment values can be acquired using a that allows the user to intuitively set the adjustment values, such as the UI illustrated in FIG. 22. The material appearance correcting unit 2503 calculates adjusted material appearance signals L_a, a_a, b_a, g_a, and s_a from the material appearance adjustment values stored in the material appearance adjustment value storage unit 2502 and the material appearance signals (L, a, b, g, s) acquired by the material appearance signal acquiring unit 1102 using equations (1) to (5). The material appearance mapping unit 1103 according to the third exemplary embodiment converts the adjusted material appearance signals corrected by the material appearance correcting unit 2503 into the material appearance signals (L′, a′, b′, g′, s′) corresponding to the material appearance reproducible by the image printing apparatus 800 through the above-described color mapping and gloss mapping.

As described above, according to the third exemplary embodiment, the material appearance reproducing system includes an adjustment unit that controls the image clarity in terms of the gloss. That is, the material appearance reproducing system includes an adjustment unit that controls the sharpness of the illumination image produced by reflection at a surface of an object to be reproduced. In this manner, for example, even when the image clarity of the output reproduced object differs from the desired image clarity, the gloss of the reproduced object can be adjusted to the desired gloss. In addition, according to the third exemplary embodiment, the material appearance reproducing system includes an adjustment unit that controls the specular gloss in terms of the gloss. That is, the material appearance reproducing system includes an adjustment unit that controls the brightness of the illumination image generated by reflection at a surface of the object to be reproduced. In this manner, even when the specular gloss of the output reproduced object differs from the desired specular gloss, the gloss of the reproduced object can he adjusted to the desired gloss. Furthermore, the material appearance reproducing system according to the third exemplary embodiment includes two gloss adjustment units in terms of gloss, one of which controls the image clarity while the other controls the specular gloss. Even when the specular gloss is adjusted, the reproducibility of the image clarity is not improved. In addition, even when the image clarity is adjusted, the reproducibility of the specular gloss is not improved. Accordingly, to adjust the gloss of the reproduced object to the desired gloss, it is desirable that the material appearance reproducing system include two gloss adjustment units, one of which controls the image clarity while the other controls the specular gloss.

In addition, according to the third exemplary embodiment, the material appearance reproducing system acquires the above-described adjustment information by using a UI that displays images having different sharpness levels. In general, the users are not aware that the gloss includes the image clarity element and that the image clarity is a property regarding the sharpness of an image produced by reflection at a surface of the object. Accordingly, the user gets in a situation where the user cannot figure out which adjustment produces desired gloss and, thus, the user repeatedly performs the adjustment operation. By displaying images having different sharpness levels in the UI used to acquire the adjustment values of the gloss, the user can intuitively recognize that the sharpness of the illumination image produced by reflection at a surface of the object to be produced can be adjusted. As a result, the user does not get in a situation where the user cannot figure out which adjustment causes which effect and, thus, the user can obtain a reproduced object of a desired material appearance without repeating the adjustment operation. In addition, the material appearance reproducing system according to the third exemplary embodiment obtains the above-described adjustment information using a UI that displays images having different brightness levels and images having different sharpness levels. It is not generally known that the gloss has two elements, that is, the specular gloss and the image clarity and that the specular gloss represents the property regarding the brightness of an image produced by reflection at a surface of the object and the image clarity represents the property regarding the sharpness of the image produced by reflection at a surface of the object. Accordingly, the user gets in a situation where the user cannot figure out which adjustment produces desired gloss and, thus, the user repeatedly performs the adjustment operation. By displaying the above-described images in the UI used to acquire the adjustment values of the gloss, the user can be intuitively aware that the two elements, that is, the brightness of the illumination image produced by reflection at s surface of the object to be reproduced and the sharpness of the illumination image produced by reflection at a surface of the object to be reproduced can be adjusted. As a result, the user does not get in a situation where the user cannot figure out which adjustment causes which effect and, thus, the user can obtain the reproduced object of a desired material appearance without repeating the adjustment operation.

### First Modification 2

A UI for acquiring the adjustment values of the gloss according to the present modification that, differs from the UI according to the third exemplary embodiment is described below.

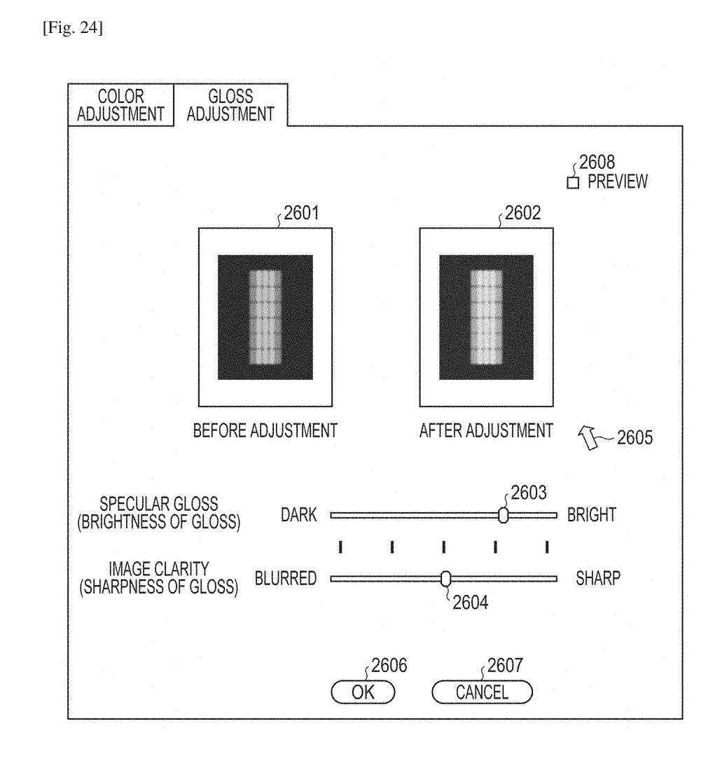

FIG. 24 is a schematic illustration of a UI for adjusting the gloss according to the first modification. An image indicating the gloss properties prior to adjustment is displayed in a display area 2601. More specifically, the illumination image having adjustment values Δg and Δs each set to zero is displayed. The illumination image is an image indicating the level of the specular gloss and the level of the image clarity of an object and is the pseudo image of the illumination light source produced by reflection at a surface of the object. In addition, an image indicating the gloss properties after adjustment is displayed in a display area 2602. In an initial stage, the same illumination images are displayed in both the display area 2601 and display area 2602. In addition, a slide bar 2603 is used to set the adjustment value Δg of the specular gloss, and a slide bar 2604 is used to set the adjustment value Δs of the image clarity. Each of the levels of the adjustment value Δg and the adjustment value Δs is indicated by a slider position in the corresponding slide bar. A value “0”, which indicates no adjustment, is assigned to the midpoint of each of the slide bars. In addition, the value positively increases toward the right from the midpoint, and the value negatively decreases toward the left from the midpoint. If the slider position is moved by using a mouse pointer 2605, a value assigned to the slider position is tentatively set in the adjustment value, and an OK button 2606 is enabled. At the same time, the image in the display area 2602 is updated so that the illumination image corresponding to the tentatively set adjustment value is displayed. For example, if Δg is tentatively set to a positive value, an illumination image having a brightness that is brighter than that of the image displayed in the display area 2601 is displayed. A brighter illumination image is displayed with increasing tentatively set Δg. If the Δs is tentatively set to a negative value, an illumination image that is more blurred than the image displayed in the display area 2601 is displayed in the display area 2602. If the OK button 2606 is selected, the adjustment value is finally set to the tentatively set value. However, if a cancel button 2607 is selected, the adjustment value Δg and the adjustment value Δs are set to “0”, which indicates no adjustment.

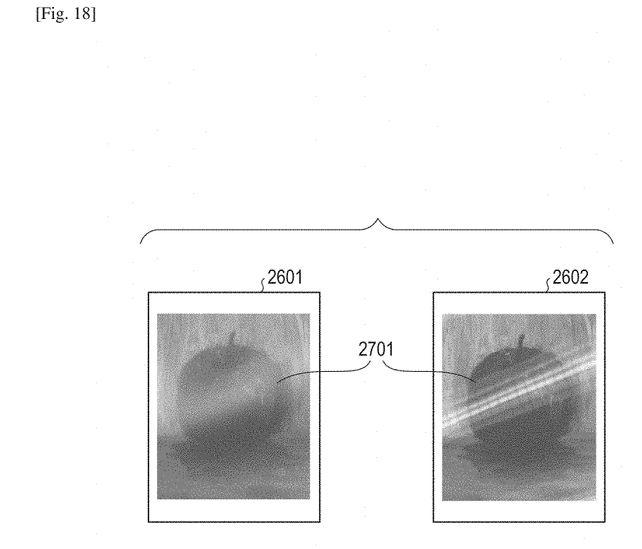

In addition, if an output preview check box 2608 is checked, the image in the display area 2601 is changed to a CG image of the object to be reproduced corresponding to the input material appearance data input in step S101. At the same time, the image in the display area 2602 is changed to a CG image of the object to be reproduced that is corrected using the tentatively set adjustment value. The CG image is an image obtained by simulating the appearance of the object to be reproduced viewed in the specular direction of a predetermined illumination light source when the object is illuminated by the illumination light source under predetermined conditions. FIG. 18 is a schematic illustration of an example of the CG images displayed in the display area 2601 and the display area 2602. An illumination image 2701 is an image of the illumination light source produced by reflection at a surface of the oil painting of an apple, which is the object to be reproduced. The object to be reproduced displayed in the display area 2601 indicates the illumination image corresponding to the specular gloss and the image clarity before adjustment. In addition, the object to be reproduced displayed in the display area 2602 indicates the illumination image corresponding to the specular gloss and the image clarity after the adjustment. By comparing the illumination image in the CG image displayed in the display area 2601 with the illumination image in the CG image displayed in the display area 2602, the user can recognize the difference in the gloss before and after the adjustment for the object to be reproduced indicated by the input data. By moving the slider position in the slide bar 2603 or the slide bar 2604, the corresponding adjustment value is tentatively set to a value corresponding to the slider position, and the image in the display area 2602 is updated. Preferably, by moving the mouse pointer (not illustrated) over the CG image, the direction of observation in the CG simulation is changed in accordance with the position of the mouse pointer. Thus, the appearance viewed in the direction of observation corresponding to the position of the mouse pointer is exhibited in this manner, the user can recognize the difference in the gloss before and after the adjustment in a variety of directions of observation. By changing the direction of lighting instead of the direction of observation, the appearance may be exhibited. In addition, the conditions of the CG simulation may be changed. For example, the type of illumination light source and the background scene may be selectable. If the output preview check box 2608 is unchecked, each of the images in the display area 2601 and the display area 2602 is changed to the original illumination image.

More preferably, the images displayed in the display areas 2601 and 2602 when the output preview check box 2608 is checked are CU images of the object to be reproduced corresponding to the material appearance data after the material appearance mapping performed in step 52303. By employing such a configuration, the image corresponding to the material appearance of the reproduced object actually output after the material appearance mapping can be examined before being output.

Note that the illumination image in the gloss adjustment UI according to the third exemplary embodiment may be an image corresponding to the input material appearance data. Alternatively, the image may be an image corresponding to the material appearance data after the material appearance mapping.

As described above, according to the first modification, the material appearance reproducing system acquires the above-described adjustment information using a user interface displaying the images having the sharpness that varies in accordance with an instruction provided externally. When adjustment is made, the sharpness of the illumination image produced by reflection at a surface of the object changes and, thus, the user can intuitively figure out the adjusted sharpness of the illumination image. As a result, the reproduced object having a desired image clarity can be obtained without repeating the adjustment operation. In addition, according to the first modification, the material appearance reproducing system acquires the adjustment information using user interface displaying images each exhibiting the sharpness and brightness of the illumination image that vary in accordance with an instruction provided externally. If the adjustment is made, the sharpness and brightness of the illumination image produced by reflection at a surface of the object vary. Thus, the user can intuitively recognize that the two elements, that is, the sharpness and brightness of the illumination image can be adjusted. As a result, a reproduced object having a desired material appearance can be obtained without repeating the adjustment operation.

In addition, according to the first modification, the material appearance reproducing system acquires the above-described adjustment information using a user interface displaying the images that vary in accordance with an instruction provided externally and that correspond to the input material appearance data. Thus, the gloss can be adjusted using the image of the object to be reproduced indicated by the input data. In this manner, the reproduced object having a desired material appearance can be obtained.

In addition, according to the first modification, the material appearance reproducing system acquires the above-described adjustment information using a user interface displaying the images having a sharpness that varies in accordance with an instruction provided externally and that correspond to the material appearance data obtained after the material appearance mapping. Thus, the gloss can be adjusted using the image corresponding to the material appearance of the reproduced object actually output after the material appearance mapping. In this manner, the reproduced object having a desired material appearance can be obtained.

### Other Modifications 2

The material appearance may be adjusted for a particular area instead of all the areas of input data, in such a case, the configuration of the above-described embodiments may additionally include a unit for specifying an adjustment area. In addition, the material appearance adjustment value acquiring unit 2501 may acquire the adjustment value for the specified adjustment area, and the material appearance correcting unit 2503 may correct the material appearance signal of only the specified adjustment area. Furthermore, the adjustment operation may be performed a plurality of times as needed. In such a case, a unit for acquiring information as to whether additional adjustment operation is performed is further provided. In addition, after the process performed by the material appearance correcting unit 2503 is completed, the information as to whether an additional adjustment operation is performed is acquired. If an additional adjustment operation is performed, the unit for specifying the adjustment area is re-activated to specify the adjustment area. In the second and subsequent adjustment operations, the material appearance correcting unit 2503 further corrects the result of previous correction. That is, instead of the input material appearance signals (L, a, b, g, s) in equations (1) to (5), the input material appearance signals (L-a, a_a, b_a, g_a, s_a) obtained in the previous correction are used. According to the modification, the material appearance of only a particular area can be adjusted, or different adjustments can be performed on different areas. In this manner, a reproduced object having a desired material appearance can be obtained.

In addition, the material appearance adjustment value acquiring unit 2501 may restrict acquirable adjustment information in accordance with the material appearance reproducible by the material appearance reproducing apparatus. For example, even when the slide bar 2603 allow an adjustment value Δg in the range of −10 <Δg <10 to be selected, the slider is inhibited to move to the right end of the slide bar if the specular gloss Δg reproducible by the material appearance reproducing apparatus <5. According to such a modification, the adjusted value is within the reproducible range at all times. Thus, a reproduced object having a desired material appearance can be obtained without repeating the adjustment operation.

In addition, as described in the first exemplary embodiment and some modifications, the signal corresponding to the specular gloss may contain the color information in addition to the brightness information. That is, the material appearance reproducing apparatus may control the color of the illumination image produced by reflection at a surface of the object in addition to the brightness of the illumination image. For example, instead of g, three signals gL, ga, and gb may be used as the gloss signal corresponding to the specular gloss. Note that gL, ga, and gb are signals corresponding to L*, a*, and b* of the CIELAB color space regarding the specular reflection light, respectively. In such a case, the material appearance adjustment value acquiring unit 2501 has a configuration to acquire the adjustment value of the chromaticity in addition to the adjustment value of the brightness as the adjustment value of the specular gloss. For example, by using the slide bar 2603 of the adjustment acquiring UI illustrated in 24, an adjustment value ΔgL regarding the brightness of the gloss is acquired instead of Δg. In addition, a UI for acquiring adjustment values Δga and Δgb regarding the chromaticity of the gloss is further provided. For example, the adjustment values of a red component and a green component of the specular reflection light are acquired by using the slide bar for acquiring the adjustment value Δga. In addition, the adjustment values of a yellow component and a blue component of the specular reflection light are acquired by using the slide bar for acquiring the adjustment value Δgb. Alternatively, in another example, a two-dimensional plane having axes of Δga and Δgb may be displayed in a UI. By acquiring any given position in the plane, a combination of Δga and AΔb may be acquired. In such a case, the material appearance correcting unit 2503 adds ΔgL, Δga, and Δgb to the material appearance signals gL, ga, and gb, respectively, to obtain adjusted material appearance signals. According to the present modification, the color of the specular reflection light can be also adjusted. Thus, the reproduced object having a desired material appearance can be obtained.

In addition, the images having different brightness levels or having different sharpness levels displayed in the UI for acquiring the material appearance adjustment values need not be the images of the illumination light source. That is, the images 2401 to 2408 illustrated in FIG. 22 and the images 2601 and 2602 illustrated in FIG. 24 need not be the images of the illumination light source. Although the image of the illumination light source having a high luminance is desirable to determine the specular gloss and the image clarity of an object, another image may be employed.

### Other Embodiments 1

The functional configuration of the material appearance reproducing system may be a configuration in which part or whole of the above-described configuration achieved using the host 700 is achieved by the image printing apparatus 800. In addition, while the above-described exemplary embodiments have been described with reference to six types of recording material (C, M, Y, K, A, and B), another type of recording material may be used. For example, a red recording material, a white recording material, or a gold recording material may be used. In addition, three or more types of gloss control agent may be used. While the above-described exemplary embodiments have been described with reference to a serial inkjet printer serving as the material appearance re-producing apparatus, a full-line inkjet printer, an electrophotographic printer, a sub-limation printer, or a silk printing may be used as the material appearance reproducing apparatus. Alternatively, a UV printer that prints a surface shape or a 3D printer that prints a 3D shape may be used. In addition to printers, the present technology may be applied to image display apparatuses, such as a display or a projector.

All the areas of the material appearance data need not be processed using the technique described in the above exemplary embodiments. A technique in which the technique of the above-described embodiment is not applied to some of the areas and a technique in which the technique of the above-described exemplary embodiment is applied to only some of the areas are encompassed within the scope and spirit of the present invention. For example, some of the areas of the material appearance data may be reproduced using a particular color material without performing the material appearance mapping.

In addition, the present invention can be achieved by supplying a program that provides at least one function of the above-described exemplary embodiment to a system or an apparatus via a network or a recording medium and reading out and executing the program using at least one processor of the system or the apparatus. Alternatively, the present invention can be achieved by a circuit (e.g., ASIC) that provides at least one function of the above-described exemplary embodiment.

According to the present invention, the image processing for obtaining a reproduced object having a desired material appearance using a reproducible range of the material appearance reproducing apparatus can be provided.

### Other Embodiments 2

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to he understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-254595, filed Dec. 16, 2014, which is hereby incorporated by reference herein in its entirety.

1. An image processing apparatus comprising:
an input unit configured to receive first material appearance data representing a material appearance of an image;
a material appearance mapping unit configured to convert the first material appearance data into second material appearance data corresponding to a material appearance reproducible by a material appearance reproducing apparatus; and
a conversion unit configured to convert the second material appearance data into control data for reproducing the material appearance of the image using the material appearance reproducing apparatus,
wherein the first material appearance data includes a gloss signal corresponding to a specular gloss and a gloss signal corresponding to an image clarity.

2. The image processing apparatus according to claim 1, wherein the first material appearance data includes a gloss signal,
wherein when a first gloss signal is defined as the gloss signal of the first material appearance data and a second gloss signal is defined as the gloss signal of the second material appearance data, the material appearance mapping unit converts the first gloss signal of an area of interest among at least some areas of the image into the second gloss signal on the basis of the first material appearance data of the area of interest and the first material appearance data of areas of non interest.

3. The image processing apparatus according to claim 2, wherein the material appearance mapping unit sets information regarding a magnitude of a gloss change for each of the image areas on the basis of the first material appearance data of the area of interest and the area of non interest and converts the first gloss signal of the area of interest into the second gloss signal on the basis of the information.

4. The image processing apparatus according to claim 3, wherein when a specular gloss error is defined as a difference between a gloss signal corresponding to the specular gloss of the first gloss signal and a gloss signal corresponding to the specular gloss of the second gloss signal, the material appearance mapping unit converts the first material appearance data into the second material appearance data so that a specular gloss error in a first image area in which the magnitude of the gloss change indicated by the information is within a first range is smaller than a specular gloss error in a second image area in which the magnitude of the gloss change indicated by the information is within a second range that is smaller than the first range.

5. The image processing apparatus according to claim 3, wherein when an image clarity error is defined as a difference between a gloss signal corresponding to the image clarity of the first gloss signal and a gloss signal corresponding to the image clarity of the second gloss signal, the material appearance mapping unit converts the first material appearance data into the second material appearance data so that the image clarity error in a first image area in which a magnitude of the gloss change indicated by the information is within a first range is smaller than the image clarity error in a second image area in which the gloss change indicated by the information is within a second range that is larger than the first range.

6. The image processing apparatus according to claim 3, wherein when a block is defined as a set of one or a plurality of consecutive image areas neighboring image areas of which have a difference in gloss signal that is less than a predetermined threshold value, the material appearance mapping unit acquires information regarding the size of a block including the area of interest and converts a gloss signal so that the gloss change increases with decreasing size of the block.

7. The image processing apparatus according to claim 3, wherein when a third gloss signal is defined as a gloss signal in the case in which the lowpass filter is applied to the spatial distribution of the first gloss signal, the material appearance mapping unit acquires information regarding a difference between the first gloss signal and the third gloss signal of the area of interest and converts the gloss signal so that the gloss change increases with increasing difference in the gloss signal.

8. An image processing apparatus comprising:
an input unit configured to receive first material appearance data representing a material appearance of an image;
a mapping unit configured to convert the first material appearance data into second material appearance data corresponding to a material appearance reproducible by a material appearance reproducing apparatus in a space having axes of at least a specular gloss and an image clarity; and
a conversion unit configured to convert the second material appearance data into control data for reproducing the material appearance of the image using the material appearance reproducing apparatus.

9. An image processing method comprising:
receiving first material appearance data representing a material appearance of an image;
converting the first material appearance data into second material appearance data corresponding to a material appearance reproducible by a material appearance reproducing apparatus; and
converting the second material appearance data into control data for reproducing the material appearance of the image using the material appearance reproducing apparatus,
wherein the first material appearance data includes a gloss signal corresponding to a specular gloss and a gloss signal corresponding to an image clarity.

10. The image processing method according to claim 9, wherein the first material appearance data includes a gloss signal,
wherein when a first gloss signal is defined as the gloss signal of the first material appearance data and a second gloss signal is defined as the gloss signal of the second material appearance data, the converting the first material appearance data into second material appearance data includes converting the first gloss signal of an area of interest among at least some areas of the image into the second gloss signal on the basis of the first material appearance data of the area of interest and the first material appearance data of areas of non interest.

11. The image processing apparatus according to claim 1, further comprising:
an acquiring unit configured to acquire adjustment information for adjusting the material appearance of an image; and
a material appearance adjusting unit configured to perform a process on the basis of the acquired adjustment information,
wherein the acquiring unit acquires the adjustment information using a user interface displaying images having different sharpnesses.

12. The image processing apparatus according to claim 1, further comprising:
an acquiring unit configured to acquire adjustment information for adjusting the material appearance of an image; and
a material appearance adjusting unit configured to perform a process on the basis of the acquired adjustment information,
wherein the acquiring unit acquires the adjustment information using a user interface displaying an image having a sharpness that varies in accordance with an instruction provided externally.

13. The image processing apparatus according to claim 11, wherein the image displayed in the user interface is an image corresponding to the second material appearance data.

14. The image processing apparatus according to claim 11, wherein the image displayed in the user interface is an image of an illumination light source.

15. The image processing apparatus according to claim 11, wherein the acquiring unit acquires, as the adjustment information, adjustment information regarding at least one of the following three elements: a brightness of the illumination image produced by reflection at a surface of an object to be reproduced, a color of the illumination image produced by reflection at a surface of the object to be reproduced, and a sharpness of the illumination image produced by reflection at a surface of the object to be reproduced, and
wherein the material appearance adjusting unit corrects the gloss signal on the basis of the acquired adjustment information.

16. The image processing apparatus according to claim 11, wherein the user interface limits a range of the acquirable adjustment information in accordance with the material appearance reproducible by the material appearance reproducing apparatus.

17. An image processing method comprising:
receiving first material appearance data representing a material appearance of an image;
converting the first material appearance data into second material appearance data corresponding to a material appearance reproducible by a material appearance reproducing apparatus in a space having axes of at least a specular gloss and an image clarity; and
converting the second material appearance data into control data for reproducing the material appearance of the image using the material appearance reproducing apparatus.

18. A non-transitory computer readable storage medium storing computer readable program code, the program code performs:
receiving first material appearance data representing a material appearance of an image;
converting the first material appearance data into second material appearance data corresponding to a material appearance reproducible by a material appearance reproducing apparatus in a space having axes of at least a specular gloss and an image clarity; and
converting the second material appearance data into control data for reproducing the material appearance of the image using the material appearance reproducing apparatus.
